(19) United States
(12) Patent Application Publication
(10) Pub. No.: US 2018/0224473 A1
(43) Pub. Date: Aug. 9, 2018

(54) SCHEDULING ANALYSIS AND THROUGHPUT OF MACROMOLECULAR SOLUTIONS

(71) Applicant: ADVANCED POLYMER MONITORING TECHNOLOGIES, INC., New Orleans, LA (US)

(72) Inventor: Wayne Frederick Reed, New Orleans, LA (US)

(21) Appl. No.: 15/746,268

(22) PCT Filed: Jul. 21, 2016
(86) PCT No.: PCT/US2016/043410

§ 371 Date: Jan. 19, 2018

Related U.S. Application Data
(60) Provisional application No. 62/195,156, filed on Jul. 21, 2015.

(51) Int. Cl. G01N 35/00; G01N 35/10; G01N 21/53

(52) U.S. Cl. CPC G01N 35/0092; G01N 35/10; G01N 2021/4726; G01N 2035/1062; G01N 21/53

(57) ABSTRACT

A device, method, and system for scheduling the analytical testing and throughput of macromolecular solutions based on light scattering measurements of one or more time dependent macromolecular solution characteristics. A device that includes a plurality of monitoring reservoirs, each configured to receive a macromolecular solution sample, coupled to a light scattering detection instrument configured to monitor light scattering from the plurality of macromolecular solution samples. The device further includes a computing device configured to measure a predetermined time dependent solution characteristic based on the monitored light scattering data and further configured to determine a time for performing an operation on one or more of the macromolecular solution samples based on the predetermined time dependent characteristic measurement.

### CROSS REFERENCE TO RELATED APPLICATIONS

This application claims priority from U.S. provisional application No. 62/195,156, entitled “SCHEDULING ANALYSIS AND THROUGHPUT OF MACROMOLECULAR SOLUTIONS,” filed on Jul. 21, 2015, which is incorporated by reference in its entirety, for all purposes, herein.

### FIELD OF TECHNOLOGY

The present disclosure is directed to devices, methods, and systems for scheduling the analysis and throughput of macromolecular solutions.

### BACKGROUND

A major area of current pharmaceutical and biotechnology research concerns the development and commercialization of biologic drugs. Biologic drugs are usually proteins, including monoclonal antibodies, which are developed to treat specific diseases. Attempts to regulate aggregate content in biologic drugs and to develop methods and standard materials for characterizing aggregates are ongoing. While target proteins are usually stable in their biological environment, virtually all target proteins are prone to unfold and aggregate when subjected to stressors ex vivo, such as, for example, temperature fluctuations, air/liquid interfaces, flow through syringes, pumping, mixing and filling operations during manufacturing, and movement during transportation.

The formation of aggregates may detract from the therapeutic value of biologic drugs in many ways. They can provoke immune responses which create antibodies to the drugs in the aggregate, rendering the body ‘immune’ to the therapeutic effects of the drug. They can also provoke inflammatory responses in a patient. Additionally, the formation of aggregates can result in biologically inert material which decreases bioavailability of the drug. Standard best practices call for filtration of medicines prior to administration, which can result in the filtering of the actual drug components themselves along with any aggregates or particles, limiting the effectiveness of the drug.

### SUMMARY

The present disclosure generally relates to devices, methods, and systems for scheduling the analytical testing and throughput of macromolecular solutions based on light scattering measurements of one or more time dependent macromolecular solution characteristics.

The technology of the present disclosure will become more readily apparent from the following detailed description of example embodiments as disclosed in this specification.

### BRIEF DESCRIPTION OF THE DRAWINGS

FIG. 1 illustrates an example flow cell that may be coupled to a light scattering detection instrument, according to an example embodiment of the present disclosure;

FIG. 2 illustrates an example light scattering detection instrument, according to an example embodiment of the present disclosure;

FIG. 3 illustrates an example configuration of a simultaneous multiple light scattering (SMSLS) flow cell, according to an example embodiment of the present disclosure;

FIG. 4 illustrates an example device and system, according to an example embodiment of the present disclosure;

FIG. 5 illustrates example automatic filtration elements, according to an example embodiment of the present disclosure;

FIG. 6 illustrates a plot of absolute light scattering (Rayleigh scattering ratio) versus time for monoclonal antibody (mAb) at concentrations ranging from 5 mg/ml to 120 mg/ml incubated at 50° C. for three hours, according to an example embodiment of the present disclosure;

FIG. 7 illustrates a plot of maximum linear time regime of aggregation in seconds versus concentration, according to an example embodiment of the present disclosure;

FIG. 8 illustrates a plot M_{w}/Mₒ versus time showing linear and non-linear regimes of the aggregation of a monoclonal antibody, according to an example embodiment of the present disclosure;

FIG. 9 illustrates both the AR and the linear correlation coefficient R versus time for the aggregation of a monoclonal antibody, according to an example embodiment of the present disclosure;

FIG. 10 illustrates the aggregation of a monoclonal antibody (mAb) at different temperatures for up to six days, according to an example embodiment of the present disclosure;

FIG. 11 illustrates particulation data for the same protein samples under two different conditions, stirred at 30° C. at 1,000 RPMs and unstirred but at the elevated temperature of 48° C., according to an example embodiment of the present disclosure;

FIG. 12 illustrates a 120 second swatch of the data presented in FIG. 11, according to an example embodiment of the present disclosure;

FIG. 13 illustrates particulation data for protein samples under stirring at 1,000 RPMs and 30° C. and unstirred but at the elevated temperature of 48° C., according to an example embodiment of the present disclosure;

FIG. 14 illustrates a plot demonstrating example removal of aliquots from a macromolecular solution sample based on a predetermined time dependent characteristic criterion, according to an example embodiment of the present application;

FIG. 15 illustrates the GPC UV data versus elution volume for aliquots removed from the protein aggregating at T=70° C. according to the arrows shown in FIG. 14, according to an example embodiment of the present disclosure;

FIG. 16 illustrates the corresponding light scattering data at 90° scattering angle for the same GPC injections as shown in FIG. 15, according to an example embodiment of the present disclosure;

FIG. 17 illustrates a plot of M_{W}/M_{O} or percentage monomer remaining versus time, demonstrating how GPC data can be translated back into further analysis of SMSLS data, according to an example embodiment of the present disclosure; and

FIG. 18 illustrates a plot of MW or fraction of monomer remaining versus time, computed from the data and exponential fit shown in FIG. 17, according to an example embodiment of the present disclosure.

It should be understood that the various aspects are not limited to the arrangements and instrumentality shown in the drawings.

### DETAILED DESCRIPTION

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The term “communicatively coupled” is defined as connected, either directly or indirectly through intervening components, and the connections are not necessarily limited to physical connections, but are connections that accommodate the transfer of data between the so-described components. The connections can be such that the objects are permanently connected or releasably connected.

The term “reservoir,” as used herein in reference to “monitoring reservoir,” “analysis reservoir,” and “storage reservoir” refers to any container capable of holding or containing a macromolecular solution sample or any container that is capable of holding or containing another container that holds or contains a macromolecular solution sample. As used herein, the term “monitoring reservoir” refers to any container capable of containing or holding a macromolecular solution sample, so long as the macromolecular solution sample contained therein can be monitored by the light scattering detection instrument. The term “monitoring reservoir” is intended to include, among other containers, any container configured to receive and hold another container that in turn contains or holds the macromolecular solution sample. For example, a “monitoring reservoir” may be a container configured to receive a flow cell or light-scattering cell capable of containing a macromolecular solution sample. In other cases, the “monitoring reservoir” may be a movable container capable of directly holding or containing a macromolecular solution sample, such as a flow cell or light scattering cell.

The terms “comprising,” “including” and “having” are used interchangeably in this disclosure. The terms “comprising,” “including” and “having” mean to include, but are not necessarily limited to, the things so described.

A “processor” or “process controller,” as used herein, is an electronic circuit that can make determinations based upon inputs and can actuate devices in response to the determinations made. Devices that can be actuated include, but are not limited to, pumps, gas flow controllers, temperature controllers, and stirring controllers. A processor or process controller can include a microprocessor, a microcontroller, and/or a central processing unit, among others. While a single processor can be used, the present disclosure can be implemented using a plurality of processors.

The present disclosure generally relates to devices, methods, and systems for scheduling the analytical testing and throughput of macromolecular solutions based on light scattering measurements of one or more time dependent macromolecular solution characteristics. According to at least one aspect of the present disclosure, a device for determining a time for performing an operation on one or more macromolecular solutions, based on light scattering measurements of at least one time dependent solution characteristic, is provided.

The device includes a plurality of monitoring reservoirs configured to receive a macromolecular solution sample. The device further includes a light scattering detection instrument coupled to the plurality of monitoring reservoirs. The light scattering detection instrument is configured to monitor light scattering from a plurality of macromolecular solution samples received in the monitoring reservoirs. The device further includes a computing device coupled to the light scattering detection instrument. The computing device is configured to measure a predetermined time dependent characteristic of one or more of the macromolecular solution samples based on the monitored light scattering at the light scattering detection instrument. The computing device is further configured to determine a time for performing an operation on one or more of the plurality of macromolecular solution samples based on the predetermined time dependent characteristic measurement. In at least some instances, the computing device is configured to determine a time for performing an operation on one or more of the macromolecular solution samples based on when a predetermined time dependent characteristic criterion is satisfied as monitored in time by light scattering measurements at the light scattering detection device. In at least some instances, the computing device may be further configured to cause the operation to be performed on one or more of the macromolecular solution samples received in the plurality of monitoring reservoirs at the determined time for performing an operation.

Operations that may be performed on the macromolecular solution samples may include, but are not limited to, quantitative or qualitative analytical testing of the solution, removing the macromolecular solution sample from the monitoring reservoir coupled to the light scattering detection instrument, replacing the macromolecular solution sample in the monitoring reservoir of the light scattering instrument, introducing a stressor to the macromolecular solution, transferring the macromolecular solution sample to a sample testing device, and transferring the macromolecular solution sample to a storage reservoir. For instance, the computing device may be configured to cause the removal of at least a portion of a macromolecular solution sample from a respective one of the plurality of monitoring reservoirs and cause the transfer of the removed solution to a sample testing device for analysis or to a storage reservoir for subsequent analysis or use. In other cases, the computing device may be configured to cause at least one macromolecular solution sample received in a respective one of the plurality of monitoring reservoirs to be replaced by a second macromolecular solution sample.

According to at least one aspect of the present disclosure, the computing device may be further configured to generate a schedule for the quantitative or qualitative analytical testing of at least one of the plurality of macromolecular solution samples received in the plurality of monitoring reservoirs based on the measured predetermined time dependent characteristic. In at least some instances, the computing device may be configured to generate a schedule for the quantitative or qualitative analytical testing of a macromolecular solution sample based, at least in part, on the determined time for performing an operation. In some cases, the computing device may be configured to generate a schedule for the quantitative or qualitative analytical testing of a macromolecular solution sample based on when a predetermined time dependent characteristic criterion is satisfied as monitored in time by light scattering measurements at the light scattering detection device. In at least some instances, the predetermined time dependent characteristic may be protein aggregation. In at least some instances, the time dependent characteristic criterion may be a predetermined value of M_{w}/M_{O}.

In at least some instances, the schedule may include at least one time for performing a corresponding operation on a particular macromolecular solution. In some cases, the schedule may include a series of times for performing a corresponding series of intended operations on one or more macromolecular solution samples. In some cases, the schedule may include a series of times for performing the same analytical test on a particular macromolecular solution sample. In other cases, the schedule may include a series of times for performing different analytical tests on a particular macromolecular solution sample.

In at least some instances, the computing device may be configured to generate a schedule for the quantitative or qualitative analytical testing of one or more macromolecular solution samples based, at least in part, on a performance characteristic of the sample testing device. The performance characteristic of the sample testing device may include, but is not limited to, the number of samples awaiting testing at the sample testing device, the number and timing of analytical tests awaiting performance at the sample testing device, and the calculated delay in analytical testing of the sample at the sample testing device.

In at least some instances, the computing device may be configured to cause the transfer of one or more macromolecular solution samples, or a portion thereof, to a sample testing instrument or analysis reservoir, based on the generated schedule. In at least some instances, the computing device may be configured to cause the performance of one or more quantitative or qualitative analytical tests on a macromolecular solution, at the sample testing device, based on the generated schedule.

In at least some instances, the light scattering detection instrument may be configured to simultaneously monitor light scattering from two or more of the plurality of macromolecular solution samples received in the plurality of monitoring reservoirs. In other cases, the light scattering detection instrument may monitor light scattering from the macromolecular solution samples in series. The light scattering detection instrument may, in some instances, be a simultaneous multiple light scattering (SMSLS) instrument.

In at least some instances, the macromolecular solution samples may be protein solutions, including proteins undergoing crystallization or aggregation. In other instances, the macromolecular solution samples may include, but are not limited to, synthetic polymers, polysaccharides, nanoparticles, particle/polymer hybrids, natural products, colloids, and mixtures thereof.

According to at least one aspect of the present disclosure, the device may further include a plurality of stressor modules coupled to the plurality of monitoring reservoirs. The plurality of stressor modules may be configured to introduce a stressor to at least one of the macromolecular solution samples received in the plurality of monitoring reservoirs. In at least some instances, each of the plurality of stressor modules is coupled to at least one of the plurality of monitoring reservoirs and each stressor module is respectfully configured to introduce a stressor to the macromolecular solution sample contained in at least one of the plurality of monitoring reservoirs. Stressors that may be introduced into the monitoring reservoirs by the stressor modules may include, but are not limited to, a change in temperature, agitation, shearing ultrasonication, stirring, exposure to a gas/liquid interface, exposure to a metal, exposure to an oil, exposure to a plastic, exposure to a glass, exposure to a ceramic, change in pH, change in ionic strength, change in buffer type, change in buffer strength, a surfactant, metal ions, sugars, polysaccharides, and amino acids.

According to at least one aspect of the present disclosure, the device may further include a sample transfer device coupled to the computing device. The sample transfer device may be configured to transfer at least one macromolecular solution received in the plurality of monitoring reservoirs, or a portion thereof, to an analysis reservoir configured to receive a macromolecular solution sample for analytical testing. The sample transfer device may be configured to transfer a corresponding one of the macromolecular solution samples to the analysis reservoir at the time for performing an operation determined by the computing device for the corresponding macromolecular solution sample. In other cases, the sample transfer device may be configured to transfer a corresponding one of the macromolecular solution samples to the analysis reservoir based on the schedule generated by the computing device.

The computing device may be configured to cause the sample transfer device to transfer a corresponding one of the macromolecular solution samples to the analysis reservoir at the time for performing an operation determined by the computing device for the macromolecular solution sample. In at least some instances, the computing device may be configured to cause the sample transfer device to transfer a corresponding one of the macromolecular solution samples to the analysis reservoir based on the schedule generated by the computing device.

The sample transfer device may include, but is not limited to, a robotic device, a Cartesian robotic arm, a translatable stage, a rotary stage, an automated sample cell holder, and an intelligent autosampler. The sample transfer device may be configured to target a macromolecular solution sample received in the plurality of monitoring reservoirs using a specified coordinate system or axis-grid. In at least some instances, the sample transfer device may include a hollow needle or pipette configured to extract fluid from one or more of the plurality of monitoring reservoirs.

According to at least one aspect of the present disclosure, the device may further include a sample testing device. The sample testing device may include at least one analysis reservoir. In at least some instances, the analysis reservoir may be configured to receive a macromolecular solution sample, or portion thereof, from the sample transfer device. The sample testing device is configured to perform at least one analytical test on at least one macromolecular solution sample in an analysis reservoir. The sample testing device may be, for example, a gel permeation chromatography (GPC) instrument, a differential scanning calorimetry (DSC) instrument, a thermogravimetric analysis (TGA) instrument, an X-ray diffractometer, an ultracentrifuge, an electron microscope, a calorimeter, a video microscope, or combinations thereof.

The analytical test may be either quantitative or qualitative. For example, the sample testing device may be configured to perform gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, ultraviolet absorption, video microscopy, video particle sizing, light occlusion particle sizing, ultracentrifugation, or combinations thereof.

In at least some instances, the analysis reservoir may be an automated sample cell holder or an intelligent autosampler. In other cases, the analysis reservoir may be a sample loop of a GPC configured to inject a macromolecular solution sample, or a portion thereof, into a GPC column. In at least some instances, the sample testing device may be configured to perform a plurality of analytical tests on at least one macromolecular solution sample received in the analysis reservoir at predetermined time points determined by the computing device based on the predetermined time dependent characteristic measurements.

According to at least one aspect of the present disclosure, the device may include at least one storage reservoir configured to receive a macromolecular solution sample. In at least some instances, the sample transfer device may be configured to transfer at least one macromolecular solution sample received in the plurality of monitoring reservoirs, or portion thereof, to the at least one storage reservoir. In at least some instances, the computing device may be configured to determine a delay in the analytical testing at the sample testing device. In such cases, the computing device may be configured to cause the sample transfer device to transfer a macromolecular solution sample, or portion thereof, to the at least one storage reservoir based on the time for performing an operation determination. In at least some instances, the computing device may be configured to transfer a macromolecular solution sample, or portion thereof, to a storage reservoir in accordance with the schedule generated by the computing device. In some cases, the storage reservoir may be an automated sample cell holder or an intelligent autosampler.

The monitoring reservoir included in the presently disclosed device, method, and system, may be any container capable of containing or holding a macromolecular solution sample, so long as the macromolecular solution sample contained therein can be monitored by the light scattering detection instrument. In at least some instances, the monitoring reservoir may be a container configured to receive and hold another container that in turn contains or holds the macromolecular solution sample. For example, the monitoring reservoir may be a flow cell or a light scattering cell. In other cases, the monitoring reservoir may be configured to receive a flow cell or a light scattering cell containing a macromolecular solution sample.

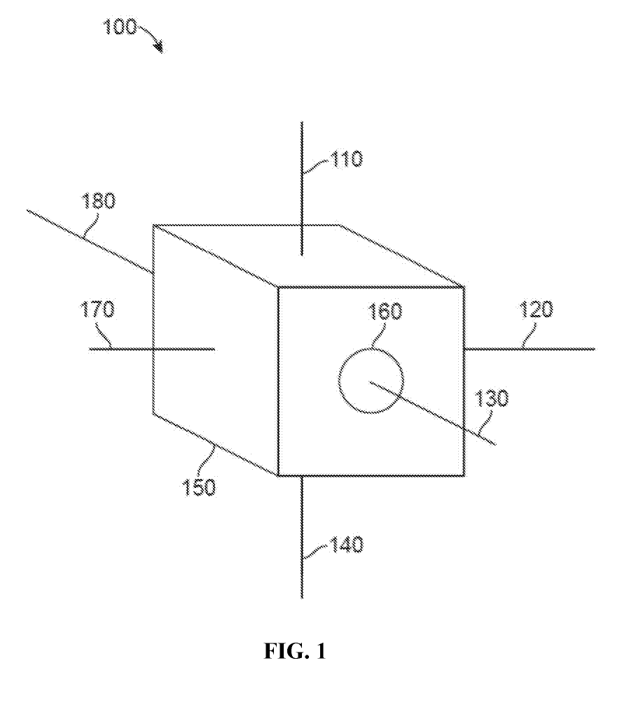

FIG. 1 illustrates an example flow cell that may serve as a monitoring reservoir, or otherwise be received in a monitoring reservoir, according to at least one example embodiment of the present disclosure. The flow cell 100 includes a solution flow input port 140 and a solution flow output port 120. The flow cell 100 further includes a through window 160 providing for a laser beam input path 130 and a laser beam output path 180. Flow cell 100 also includes a vertical light scattering fiber 170 and a depolarized light scattering fiber 110.

The presently disclosed light scattering detection instrument may implement a depolarized light scattering system and method. The performance of the depolarization detection system can be assessed using depolarization ratios of organic solvents that are well known (e.g. toluene, carbon disulfide, etc.). The extinction of the polarized component compared to the depolarized component can be used to determine performance. When an isotropic scatterer is used, such as a latex sphere of diameter <10 nm, a very high performance system having as little as 10⁻⁴ as the ratio of depolarized (e.g. leakage in this case) to polarized signal can be achieved. In principle, the small latex spheres will not depolarize the incident light upon scattering.

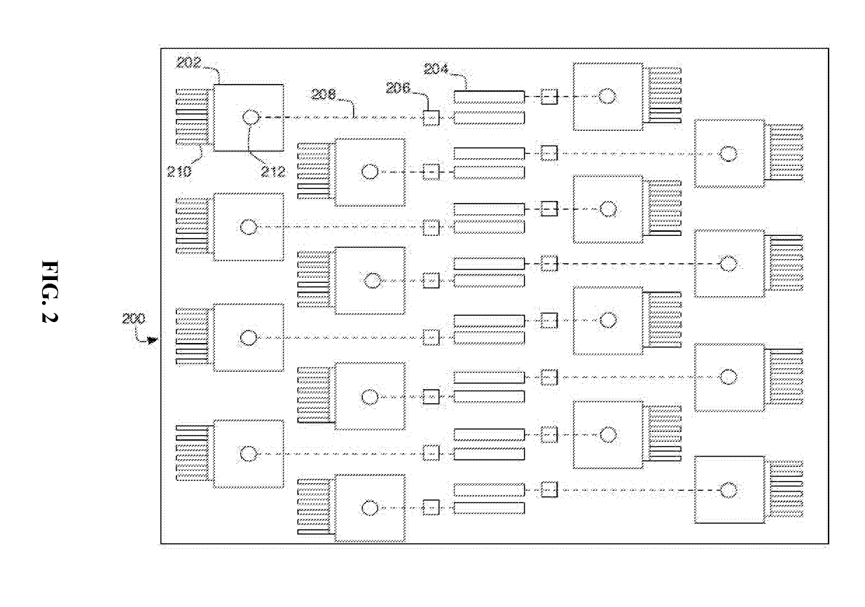

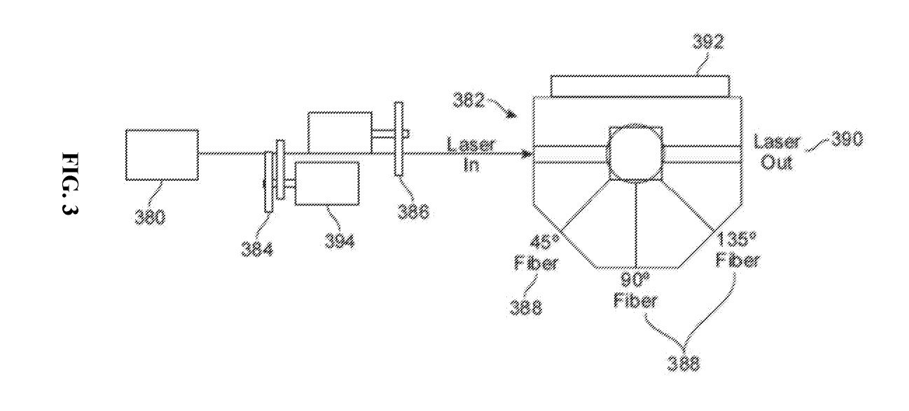

FIG. 2 illustrates an example light scattering detection instrument, according to an example embodiment of the present disclosure. As depicted in FIG. 2, the light scattering detection instrument is a simultaneous multiple light scattering (SMSLS) instrument. There are sixteen SMSLS flow cells 202 depicted in FIG. 2, however, any number of flow cells is within the spirit and scope of the present disclosure. The SMSLS flow cells 202 depicted in FIG. 2, may be, for example, the flow cell 100 depicted in FIG. 1 or the flow cell 382 depicted in FIG. 3. In some embodiments the number of SMSLS flow cells 202 may vary to be greater or less than sixteen. In some embodiments the interior of the SMSLS flow cell can be square. One of ordinary skill in the art will appreciate that many variations of the interior SMSLS flow cell shape can be used without parting from the spirit of the disclosed technology. The SMSLS flow cells 202 are coupled to one or temperature control devices 210 capable of controlled or uncontrolled heating of the SMSLS flow cell. In some embodiments a peltier device is used in the temperature control configuration to also allow cooling of the SMSLS flow cell 202, or a resistance heating unit, such as a high resistance wire, etc. In some embodiments, in addition to the peltier device each SMSLS flow cell can also be coupled to a fan to exhaust heat extracted from the SMSLS flow cell. In at least some instances, temperature control devices 210 may be a stressor module.

Each SMSLS flow cell is configured to receive light from a light source, such as a laser 204. The laser 204 is positioned to emit laser light 208 into the flow cell 202. The laser light 208 may pass through neutral density filters 206 to regulate the intensity of laser light entering the flow cell 202. In some embodiments, fiber optics 212 in the SMSLS flow cell 202 may transmit the laser light emitted into the flow cell to a photodetector (not shown). In some embodiments the photodetector may be a charged couple device (CCD), a photomultiplier, or a photodiode.

FIG. 3 illustrates an example configuration of an SMSLS flow cell, according to an example embodiment of the present disclosure. A laser 380 is configured to emit light into a SMSLS flow cell 382. In some embodiments neutral density (ND) filters 384 are utilized to regulate the intensity of laser light emitted into the SMSLS cell 382. The half-wave (λ/2) plate 386 through which the laser 380 light can pass through can switch the incident polarization from vertical to horizontal and the photodetector used for ‘normal scattering’ detection in the scattering plane will measure the depolarized scattering. The half-wave plate approach can be used for both batch and flow cells. Fiber optics 388 within the SMSLS flow cell are used to transmit laser light emitted from the laser to a photodetector device. In some embodiments the fiber optics 388 are positioned at one or more desired angles, such as 45°, 90° or 135° to capture laser light scattered at each angle. One of ordinary skill in the art will appreciate that fiber optics 388 may be positioned at other angles to capture laser light scattered. Laser light that travels out 390 of the SMSLS flow cell 382 is disseminated to a laser trap (not shown). The peltier device 392 is utilized for cooling and a separate heating element is utilized for heating. A temperature control device can be set to regulate the temperature of the SMSLS sample cell. The stepper motor 394 is coupled to a magnet which creates a magnetic field within the SMSLS. As the stepper motor 394 rotates at a given revolution per minute (RPM), the magnetic field is changed within the cell which in turn rotates a magnetic stir bar within the SMSLS cell at the specified RPM.

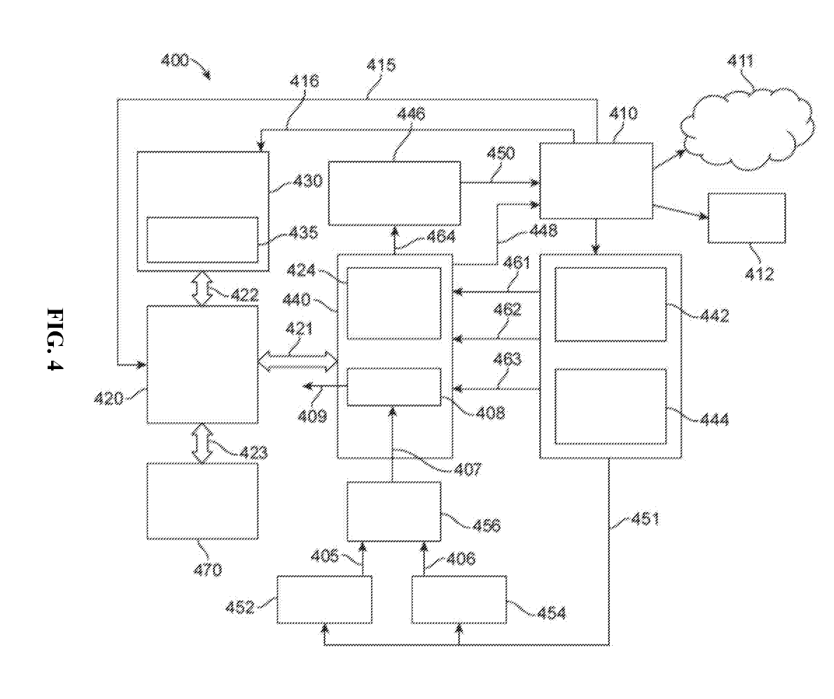

FIG. 4 illustrates an example device and system for scheduling the analytical testing and throughput of macromolecular solutions based on light scattering measurements of one or more time dependent macromolecular solution characteristics, according to an example embodiment of the present disclosure. Device 400 includes a plurality of monitoring reservoirs 440 configured to receive a macromolecular solution sample. Monitoring reservoirs 440 can be, for example, light scattering flow cells 408 or batch cells 424. In other cases, monitoring reservoirs 440 can be configured to receive light scattering flow cells 408 or batch cells 424. In a flow cell, fluid flows through the cell while laser light emitted into the cell flows through a portion of the flowing fluid stream. Peristaltic pumps 452, 454 can be utilized to pump different materials 405, 406 into a mixing manifold 456 to mix different materials prior to flowing the materials through the flow cells 408. For example, a first peristaltic pump 452 may pump 405 a protein into the mixing manifold and a second peristaltic pump 454 can pump 406 buffer into the mixing manifold 456 producing a mixed stream of protein and buffer exiting the mixing manifold 456 and entering 407 into the flow cells 408. In at least some instances, the pumped solution stream can exit the flow cells 408 at a flow output port 409. One of ordinary skill in the art will appreciate that other pump types may be used in conjunction the flow cells and mixing manifolds. For example, in some embodiments a positive displacement pump may be used to pump materials into the mixing manifold. In a batch cell, the composition of material within the batch cell is prepared independently and individually introduced into each batch cell in a vessel such as an optical glass cuvette or other similar vessel manually or by a sample transfer device. In at least some instances, the device 400 can include batch cells, flow cells, or any combination of batch and flow cells.

According to at least one aspect of the present disclosure, device 400 can include individual cell controls 442 configured to set up the samples within the individual cells. The individual cell controls can include software components including a user interface for receiving instructions from an operator regarding the setup and variables tested among the individual cells. In some embodiments, the individual cell controls 442 can also include an interface to designate sampling statistics and intervals of interest. In some embodiments the individual cell controls 442 can also control inputs 405, 406, 407 into flow cells 408 or monitoring reservoirs 440 for providing material to the flow cells 408 or monitoring reservoirs 440. In such cases, the individual cell controls 442 are communicatively coupled 451 with pumps 452, 454.

According to at least one aspect of the present disclosure, device 400 can include one or more stressor module(s) 444 coupled to the plurality of monitoring reservoirs 440. The stressor module(s) 444 may be configured to control the stressors associated with each individual cell. In some embodiments the stressors can include, but are not limited to a change in temperature, including freezing and thawing, application of shear forces, introduction of certain surfaces, such as metals, plastics, gas bubbles, glass, oils, specific ions, chelating or other chemical agents, ultrasound, light and other forms of radiation. The stressor module(s) 444 allows for the temperature, stirring, stepper motor, and other stressors associated with each cell to be controlled individually for each cell. As depicted in FIG. 4, stressor module(s) 444 may be configured to control the stressors associated with each individual cell by controlling temperature control output 461, stepping motor control output 462, and mixing motor control output 463. In at least some instances, each of the plurality of stressor module(s) 444 is coupled to at least one of the plurality of monitoring reservoirs 440 and each stressor module 444 is respectfully configured to introduce a stressor to the macromolecular solution sample contained in at least one of the plurality of monitoring reservoirs 440. In some embodiments, the stressor module 444 is a combination of software and hardware such as computer code for controlling a stepper motor, a processor for interpreting the computing code, the stepper motor hardware for creating a magnetic field about a cell, and a magnetic stirrer within the cell—collectively these all can be considered parts of a given stressor module. Other stressor modules include software, computing devices, and other instruments for introducing a stressor whether it is a form of energy, material, or any other stressor identified herein or known to those of ordinary skill in the art.

Device 400 further includes a light scattering detection instrument 446 coupled to the plurality of monitoring reservoirs 440. The light scattering detection instrument 446 is configured to monitor light scattering from a plurality of macromolecular solution samples received in the monitoring reservoirs 440. Light scattering measurements associated with one or more time dependent macromolecular solution characteristics may be detected by a photodetector included in the light scattering detection instrument. In some instances, the photodetector can be a charged couple device (CCD). In some cases, the CCD can have 2048 pixels, but the present disclosure isn't limited to CCDs of a particular pixel count. Any photodetector that can measure reflected light in a sample can be used, as will be understood by those of ordinary skill in the art. The light emitted from each laser can be transmitted 464 to a photodetector through fiber optics present in each individual sample cell or a photodetector can be coupled to each sample cell. Additional outputs associated with each monitoring reservoir 440 may include stressor information output 448, which may include, for example, the measured sample temperature, stirring motor speed, gas flow into the sample, or liquid flow into the sample.

In at least some instances, the light scattering detection instrument 446 may be configured to simultaneously monitor light scattering from two or more of the macromolecular solution samples received in the monitoring reservoirs 440. In other cases, the light scattering detection instrument 446 may monitor light scattering from the macromolecular solution samples in series. The light scattering detection instrument 446 may, in at least some instances, be a simultaneous multiple light scattering (SMSLS) instrument.

According to at least one aspect of the present disclosure, device 400 may further include a computing device 410 coupled to the light scattering detection instrument 446. In at least some instances, the computing device 410 may also be coupled with the monitoring reservoirs 440, individual cell controls 442, and/or stressor module(s) 444. The computing device 410 is configured to receive monitored light scattering data 450 from the light scattering detection instrument 446. In at least some instances, the computing device 410 may be configured to receive stressor information output data 448. The computing device 410 may be configured to measure a predetermined time dependent characteristic of one or more of the macromolecular solution samples based on the monitored light scattering data 450 acquired at the light scattering detection instrument 446. For instance, the predetermined time dependent characteristic may be protein aggregation. The computing device 410 may also be configured to determine a time for performing an operation on one or more of the plurality of macromolecular solution samples based on the predetermined time dependent characteristic measurement. In some cases, the computing device 410 may be configured to determine a time for performing an operation on one or more of the macromolecular solution samples based on when a predetermined time dependent characteristic criterion is satisfied as monitored in time by light scattering measurements at the light scattering detection instrument 446. For example, the time dependent characteristic criterion may be a predetermined value of M_{w}/M_{O}.

In at least some instances, the computing device 410 may be further configured to cause the operation to be performed on one or more of the macromolecular solution samples received in the plurality of monitoring reservoirs at the determined time for performing an operation. For example, the computing device 410 may cause the quantitative or qualitative analytical testing of the macromolecular solution, the removal of the macromolecular solution sample from the monitoring reservoir 440, the replacement of the macromolecular solution sample in the monitoring reservoir 440, the introducing of a stressor to the macromolecular solution in the monitoring reservoir 440, the transferring of the macromolecular solution sample to a sample testing device, and/or the transferring of the macromolecular solution sample to a storage reservoir. In at least some instances, the computing device 410 may be configured to cause the removal of at least a portion of a macromolecular solution sample from a respective one of the monitoring reservoirs 440 and cause the transfer of the removed solution to a sample testing device for analysis or to a storage reservoir for subsequent analysis for use. In other cases, the computing device 410 may be configured to cause at least one macromolecular solution sample received in a respective one of the monitoring reservoirs 440 to be replaced by a second macromolecular solution sample.

According to at least one aspect of the present disclosure, the computing device 410 may be further configured to generate a schedule for the quantitative or qualitative analytical testing of at least one of the macromolecular solution samples received in the monitoring reservoirs 440 based on the measured predetermined time dependent characteristic. In at least some instances, the computing device 410 may be configured to generate a schedule for the quantitative or qualitative analytical testing of a macromolecular solution sample based, at least in part, on the determined time for performing an operation. In some cases, the computing device 410 may be configured to generate a schedule for the quantitative or qualitative analytical testing of a macromolecular solution sample based on when a predetermined time dependent characteristic criterion is satisfied as monitored in time by light scattering measurements at the light scattering detection instrument 446. In at least some instances, the predetermined time dependent characteristic may be protein aggregation. In at least some instances, the time dependent characteristic criterion may be a predetermined value of M_{w}/M_{O}.

In at least some instances, the computing device 410 may be configured to cause the transfer of one or more macromolecular solution samples, or a portion thereof, to a sample testing device or analysis reservoir, based on the generated schedule. In at least some instances, the computing device may be configured to cause the performance of one or more quantitative or qualitative analytical test on a macromolecular solution, at the sample testing device, based on the generated schedule. In at least some instances, the computing device may be configured to generate a schedule for the quantitative or qualitative analytical testing of one or more macromolecular solution samples based, at least in part, on a performance characteristic of the sample testing device. The performance characteristic of the sample testing device may include, but is not limited to, the number of samples awaiting testing at the sample testing device, the number and timing of analytical tests awaiting performance at the sample testing device, and the calculated delay in analytical testing of the sample at the sample testing device.

The computing device 410 may also be communicatively coupled with a server via a network 411, allowing transfer of light scattering data 450, stressor information output data 448, predetermined time dependent macromolecular solution characteristic measurement data, determined time(s) for performing an operation on a respective macromolecular solution, and/or generated schedules for the quantitative or qualitative analytical testing of one or more macromolecular solution samples, to the server. The computing device 410 can also communicate these data, measurements, and parameters to cloud-based computer services or cloud-based data clusters via the network 411 or directly to data storage devices 412.

According to at least one aspect of the present disclosure, the device 400 may further include a sample transfer device 420 coupled 415 to the computing device 410. The sample transfer device 420 may be configured to transfer 421, 422 at least one macromolecular solution received in the monitoring reservoirs 440, or a portion thereof, to an analysis reservoir 435 configured to receive a macromolecular solution sample for analytical testing. In at least some instances, transfer of the macromolecular solution by the sample transfer device 420 may include transfer of the entire macromolecular solution or an aliquot of the solution by, for instance, a needle or pipette configured to extract fluid from one or more of the plurality of monitoring reservoirs 440 and delivering it to the analysis reservoir 435. In other instances, transfer of the macromolecular solution by the sample transfer device 420 may include removing a flow cell or light scattering cell containing the macromolecular solution from the monitoring reservoir 440 and inserting the removed flow cell or light scattering cell into the analysis reservoir 435.

The sample transfer device 420 may be configured to transfer 421, 422 a corresponding one of the macromolecular solution samples to the analysis reservoir 435 at the time for performing an operation determined by the computing device 410 for the corresponding macromolecular solution sample. In other cases, the sample transfer device 420 may be configured to transfer 421, 422 a corresponding one of the macromolecular solution samples to the analysis reservoir 435 based on the schedule generated by the computing device 410.

The computing device 410 may be configured to cause the sample transfer device 420 to transfer 421, 422 a corresponding one of the macromolecular solution samples to the analysis reservoir 435 at the time for performing an operation determined by the computing device 410 for the macromolecular solution sample. In at least some instances, the computing device 410 may be configured to cause the sample transfer device 420 to transfer 421, 422 a corresponding one of the macromolecular solution samples to the analysis reservoir 435 based on the schedule generated by the computing device 410.

The sample transfer device 420 may include, but is not limited to, a robotic device, a Cartesian robotic arm, a translatable stage, a rotary stage, an automated sample cell holder, and an intelligent autosampler. The sample transfer device 420 may be configured to target a macromolecular solution sample received in the plurality of monitoring reservoirs 440 for transfer 421 using a specified coordinate system or axis-grid. In at least some instances, the sample transfer device 420 may include a hollow needle or pipette configured to extract fluid from one or more of the plurality of monitoring reservoirs.

According to at least one aspect of the present disclosure, the device 400 may further include a sample testing device 430. The sample testing device 430 may include at least one analysis reservoir 435. In at least some instances, the analysis reservoir 435 may be configured to receive a macromolecular solution sample, or portion thereof, from the sample transfer device 420. The sample testing device 430 may be configured to perform at least one analytical test on a macromolecular solution sample in the analysis reservoir 435. The sample testing device 430 may be, for example, a gel permeation chromatography (GPC) instrument, a differential scanning calorimetry (DSC) instrument, a thermogravimetric analysis (TGA) instrument, an X-ray diffractometer, an ultracentrifuge, an electron microscope, a calorimeter, a video microscope, or combinations thereof. The analytical test performed by the sample testing device 430 may be either quantitative or qualitative. For example, the sample testing device 430 may be configured to perform gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, ultraviolet absorption, video microscopy, video particle sizing, light occlusion particle sizing, ultracentrifugation, or combinations thereof.

In at least some instances, the analysis reservoir 435 may be an automated sample cell holder or an intelligent autosampler. In other cases, the analysis reservoir 435 may be a sample loop of a GPC configured to inject a macromolecular solution sample, or a portion thereof, into a GPC column. In at least some instances, the sample testing device 430 may be configured to perform a plurality of analytical tests on at least one macromolecular solution sample received in the analysis reservoir 435 at predetermined time points determined by the computing device 410 based on the predetermined time dependent characteristic measurements.

According to at least one aspect of the present disclosure, the device may include at least one storage reservoir 470 configured to receive a macromolecular solution sample. In at least some instances, the sample transfer device 420 may be configured to transfer 421,423 at least one macromolecular solution sample received in the plurality of monitoring reservoirs 440, or portion thereof, to the at least one storage reservoir 470. In at least some instances, the computing device 410 may be configured to determine a delay in the analytical testing at the sample testing device 430. In such cases, the computing device 410 may be configured to cause the sample transfer device 430 to transfer 421, 423 a macromolecular solution sample, or portion thereof, to the at least one storage reservoir 470 based on the time for performing an operation determination. In at least some instances, the computing device 410 may be configured to transfer 421, 423 a macromolecular solution sample, or portion thereof, to a storage reservoir 470 in accordance with the schedule generated by the computing device 410. In some cases, the storage reservoir 470 may be an automated sample cell holder or an intelligent autosampler.

According to at least one aspect of the present disclosure, the device, for example the device 400 depicted in FIG. 4, may include a sample transfer device 420 in the form of a fully integrated robotic system coupled to the multiple sample light scattering detection instrument 446. Such a sample transfer device 420 would allow liquid to be removed automatically from a sample cell, such as that received in a monitoring reservoir 440, when the instrument scheduling software indicated at computing device 410. The signal for the removal would be based on algorithms that recognize specific events, such as reaching a certain value of M_{W}/Mₒ, or of M_{w}, or when a certain aggregation rate or light-scattering slope in time is attained, or when there is a qualitative change in the scattering trajectory, such as passing into a non-linear regime of scattering vs time, or such as a sharp upturn in scattering vs time, or when particulates of a certain concentration and/or size begin to form, etc. In this automated embodiment, a sample attaining the signal condition for removal would be determined by the computing device 410 and the computing device 410 would ‘call’ the sample transfer device 420 in the form of a robotic device, such as a Cartesian robot arm, and the sample transfer device 420 would then extract the desired volume of sample needed for the subsequent analytical measurements, such as GPC or ultracentrifugation.

The extraction could occur via an aspirating needle as part of the robotic device that could locate a small hole in the sample cell cap, or pierce a septum (on multiple occasions, for multiple time points, if desired). A Cartesian robot could be used for this, with the position of the cell specified in x-y coordinates, and the z-coordinate specifying the height of the needle upon arrival at the cell. The base platform of the light scattering detection instrument, or other convenient point can be taken as z=0, and the needle would arrive at a height so as to be a safe distance above the scattering cell. For SMSLS, such cells are typically square or round, with diameters or square sides of typical dimensions of 0.2 cm to 1 cm and heights around 5 cm. The sample volume, entered as a parameter for a given sample, is used to compute the plunging distance from the needle arrival height to the depth in solution needed to remove the desired amount of sample. The volume of the remaining sample solution in that cell is decremented in the control software data after the withdrawal so that any subsequent withdrawal would re-calculate the needle plunge depth, if needed.

It is noted that the automation is not limited to a Cartesian robot, and that an automated sample transfer device could involve other coordinate schemes, such as rotary stages, and systems employing cylindrical coordinates, spherical coordinates, or other coordinate system for identifying positions in three dimensions.

The subsequent automatic manipulations of a sample thus gathered would depend on the analytical measurement(s) to be made. For example, if the measurement is for GPC, the sample could be injected directly into an injection sample loop of a proximate GPC which would automatically trigger the injection into the GPC column, thus fully automating the complete light scattering, scheduling and GPC analysis procedure. In this instance, the entire robotic system coupled to the GPC would be its own type of autosampler, and no other external autosampler would be required. Each sample in the multiple sample light scattering unit would be measured in turn when and if the removal criterion or criteria are reached.

If criteria are reached for multiple sample removal faster than GPC injections can be made, then the injection will be delayed appropriately by computations made in the instrument software at the computing device 410 and signals sent to the robot. In such a case, software in the computing device 410 would indicate whether a sample is ready for injection or whether the sample should incubate further in its cell, or be removed and held in the robotically coupled syringe, or loaded into the injection loop, until the GPC is ready to accept another injection.

The removed sample could also be simply injected into a storage reservoir, such as a vial or other receptacle for further use, whether manually or via transfer to another automated device, such as a liquid handling autosampler or an automated sample preparation system such as an autopipetter. If removed aliquots are stored in vials, these could be in a holding area in or near the scattering instrument with numbered or coded locations so that the contents of each vial would be unambiguously traced to the sample cell in the scattering instrument from which it was extracted.

A further automation could be achieved in the SMSLS context by scheduling the end of an experiment and taking out a sample cell when certain criteria are reached. As described above, these could include reaching a certain value of M_{W}/Mₒ, or of M_{w}, or when a certain aggregation rate or light scattering slope in time is attained, or when there is a qualitative change in the scattering trajectory, such as passing into a non-linear regime of scattering vs time, or such as a sharp upturn in scattering vs time, or when particulates of a certain concentration and/or size begin to form.

Removing the sample cell from the sample cell holder can be achieved by equipping the robotic device with a means to grasp and transport sample cells into and out of the light scattering instrument. Specifically, the robotic device can be configured to mechanically grasp the cell, couple to it by magnetic attraction to a ferromagnetic material in the top of the cell or in its cap, use suction, or some other grasping means. In this way the sample transfer device could pick up a sample cell, transport it to a used cell collection station in or near the light scattering instrument, go to a location where further samples are queued for experimentation, grasp the next sample cell in the queue, bring it to the vacated sample cell holder, and insert the new sample into it. The robotic device can include an extraction needle for extracting sample from sample cells.

In at least one embodiment, the grasping tool could be mounted proximate to the first, displaced by a certain amount in whatever coordinate system is used, such that it does not interfere with the first device. For example, if the difference in position with respect to the aspiration tool is (xₒ,yₒ,zₒ) then these coordinates are simply taken into account when sending the grasping tool to a given cell for insertion or removal. Alternatively, the aspiration or grasping tool could move into a fixed, preferred location, effectively switching places with each other when called upon to act.

A further advantage of the grasping tool is that it would also allow for a scattering device of the SMSLS device to be used when experiments first begin. The sample cells would be queued after preparation and then inserted into sample cell holders and experiments begun in each. As noted, the APMT SMSLS platform allows completely independent operation and monitoring of each sample cell holder, so that time delays between sample loadings by the robotic device pose no problem such as, for example, complications arising from sample cell monitoring during the set-up of other sample cells.

An even further advantage of this automated cell insertion and removal system as described is that it allows for essentially non-stop use of the SMSLS instrument. Namely, once the sample cell holders are all filled at the outset, there is no need to ever turn the system off or interrupt experiments. Samples can be added to the waiting queue at any time desired, and instructions for their associated labeling and experimental conditions added into the software. The automated system will keep removing cells where completion has been reached and add the next awaiting cell in an unlimited fashion. It will continue as long as there are samples cells in the input queue.

Coupled to the above system could be an automated sample preparation system for the protein formulations that go into the sample cells. These samples could be delivered either manually or automatically to the input sample queue. There are commercially available sample preparation robots. For example, the Sotax Corporation has an automatic sample preparation station, which can extract, filter, dilute, and store liquid samples in lab-scale, milliliter and sub-milliliter quantities. In this case the automated sample preparation could prepare protein solutions for light scattering either by dilution of stock protein solutions or dissolution of dried polymers. In such an embodiment automation from sample preparation through to light scattering and subsequent analytical measurements, such as GPC, would be complete.

Cartesian and linear robots and positioning devices are offered by companies such as Parker Hannafin Corporation, Arrick robotics, Weckenmann Anlagentechnik GmbH & Co. KG, and others.

In some instances, other devices and modules can be used along with the device described above to provide additional measurements, or analysis. For example an autocorrelation module for Dynamic Light Scattering, optical bandpass filters for measuring fluorescence, or highly attenuated throughput beams can be used for measuring turbidity.

In some instances, the device can further include an automatic light modulation system for automatically monitoring, attenuating and controlling the intensity of the incident light beam or other light beam in the SMSLS systems and methods herein described. The automatic light modulation system can include a controller or processor; a plurality of neutral density filters arranged on movable member; a means for configuring the filters, such as a drive train, motor or other mechanical and/or electrical device coupled to movable member; a photodetector e.g., a CCD or photodiode, etc. coupled to the controller or processor for detecting the incident light. The controller or processor can send signals to the means for configuring the filters in response to the detected intensity of the incident light. The controller or a processor operating in a computer system can run analysis and control software for continuously and automatically monitoring incident light intensity and provide control signals to the configuration means to position the filters in appropriate filter configurations in the path of the incident light to modulate or attenuate the light as needed. While neutral density filters (i.e. those optical elements that attenuate transmitted light independently of the incident wavelength) are inexpensive and convenient for use, other items, such as plates of glass (e.g. microscope slides or slide covers) can be used to attenuate the light, as well as beam splitters, or optical filters tuned to specific wavelengths or wavelength ranges can be used.

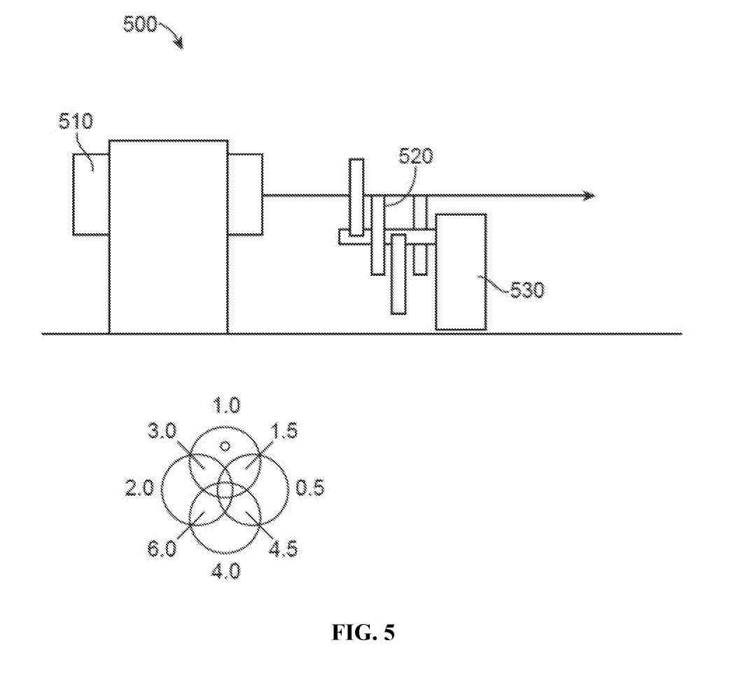

The automatic light attenuation element described above increases the range over which the input laser beam can be modulated. In some cases, the automatic light attenuation element is controlled automatically and the different filters are put into place with servo motors. FIG. 5 illustrates example automatic filtration elements according to an example embodiment of the present disclosure. Light attenuation devices can also be mounted linearly and actuated to move into position automatically with any sort of linear translation stage. It is also possible to use a single, continuous neutral density (ND) filter, either circular or linear, which allows a continuum of attenuations from nearly 0 to nearly 100% to be achieved by continuously moving around (circular device) or along (linear device) the attenuation device. As depicted in FIG. 5, automatic filtration elements 500 includes different neutral density (ND) filters 520 that may be inserted into the beam path of laser 510 by servo motor 530 to change the laser beam intensity. FIG. 5 illustrates different ND values of individual filters and combinations of filters that may be used. Each ND filter has a mass of 1 gram. Rotation of the shaft by servo motor 530 produces a different ND value for every 45 degrees of rotation with eight possible positions total.

According to at least one aspect of the present disclosure, a method of scheduling analytical testing on a macromolecular solution is provided. The method includes monitoring, at a light scattering detection instrument, light scattering from two or more macromolecular solution samples. The method further includes measuring, at a computing device, a predetermined time dependent characteristic of the two or more macromolecular solution samples based on the monitored light scattering at the light scattering detection instrument. The method further includes determining, at the computing device, a time for performing an operation on at least one of the two or more macromolecular solution samples based on a change in the predetermined time dependent characteristic measurement. In at least some instances, the predetermined time dependent characteristic may be the formation of particulates and the operation is particle characterization testing. In other cases, the predetermined time dependent characteristic may be the formation of particulates and the operation is crystallinity testing by X-ray diffraction or differential scanning calorimetry (DSC).

According to at least one aspect of the present disclosure, the method may further include causing, at the computing device, the performance of the operation on at least one of the two or more macromolecular solution samples at the determined time for performing the operation. For example, the operation may include quantitative analytical testing, qualitative analytical testing, removing the macromolecular solution sample from the light scattering detection instrument, replacing the macromolecular solution sample at the light scattering detection instrument, introducing a stressor, transferring the macromolecular solution sample to a sample testing device, and/or transferring the macromolecular solution sample to a storage reservoir.

According to at least one aspect of the present disclosure, the method may further include generating a schedule for the quantitative or qualitative analytical testing of at least one of the two or more macromolecular solution samples based on the determined time for performing an operation. In at least some instances, monitoring at the light scattering detection instrument may include simultaneously monitoring light scattering from two or more macromolecular solution samples. In other cases, monitoring at the light scattering detection instrument may include monitoring in series light scattering from two or more macromolecular solution samples. In at least some instances, the light scattering detection instrument employed in the method may be a simultaneous multiple light scattering (SMSLS) instrument.

Macromolecular solution samples that may be particularly well-suited for use in the presently disclosed method include solutions samples having one or more proteins, including proteins undergoing crystallization. The presently disclosed method is also suited to macromolecular solution samples that include, but are not limited to, synthetic polymers, polysaccharides, nanoparticles, particle/polymer hybrids, natural products, colloid particles, and combinations thereof.

According to at least one aspect of the present disclosure, the method may further include transferring, using a sample transfer device, at least one of the two or more macromolecular solution samples, or a portion thereof, to a sample testing device based on the generated schedule. The method may additionally include performing, at the sample testing device, a quantitative or qualitative analytical test on the transferred macromolecular solution sample. The schedule may include a plurality of predetermined times for quantitative or qualitative analytical testing of the same macromolecular solution sample, or a portion thereof. The method may further include performing, at the sample testing device, a plurality of quantitative or qualitative analytical tests on the same macromolecular solution sample according to the schedule comprising a plurality of predetermined times.

The sample testing device may be a gel permeation chromatography (GPC) instrument, differential scanning calorimetry (DSC) instrument, thermogravimetric analysis (TGA) instrument, an X-ray diffractometer, ultracentrifuge, electron microscope, calorimeter, video microscope, or combinations thereof. The performing of an analytical test, according to the presently disclosed method, may include analytical tests such as gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, video microscopy, ultraviolet absorption, video particle sizing, light occlusion particle sizing, and ultracentrifugation.

The method may further include replacing, at the light scattering detection instrument, at least one of the two or more macromolecular solution samples with a new macromolecular solution sample based on the generated schedule. In at least some instances, the method may further include introducing, at a stressor module, a stressor to at least one of the macromolecular solution samples. The stressor may be a change in temperature, agitation, shearing ultrasonication, stirring, exposure to a gas/liquid interface, exposure to a metal, exposure to an oil, exposure to a plastic, exposure to a glass, exposure to a ceramic, change in pH, change in ionic strength, change in buffer type, change in buffer strength, a surfactant, metal ions, sugars, polysaccharides, and amino acids.

According to at least one aspect of the present disclosure, a device for scheduling analytical testing on a macromolecular solution is provided. The device includes a light scattering device configured to monitor light scattering from a plurality of macromolecular solution samples. The device further includes at least one processor in communication with the light scattering device, wherein the processor is coupled with a non-transitory computer readable storage medium having stored therein instructions which, when executed by the at least one processor, causes the processor to: measure a predetermined time dependent characteristic of the plurality of macromolecular solution samples based on the monitored light scattering at the light scattering detection instrument; determine a time for performing an operation on at least one of the plurality macromolecular solution samples based on a change in the predetermined time dependent characteristic measurement; and generate a schedule for the quantitative or qualitative analytical testing of at least one of the two or more macromolecular solution samples based on the determined time for performing an operation.

The device may further include a sample transfer device, wherein the non-transitory computer-readable storage medium further contains a set of instructions that when executed by the at least one processor further causes the processor to cause the transfer, using the sample transfer device, of at least one macromolecular solution sample, or a portion thereof, to a sample testing device based on the generated schedule. The device may further include a sample testing device, wherein the non-transitory computer-readable storage medium further contains a set of instructions that when executed by the at least one processor further causes the processor to: cause the performance of a quantitative or qualitative analytical test on the transferred macromolecular solution sample using the sample testing device based on the generated schedule.

The continuous monitoring of macromolecular associations allowed by the presently disclosed devices, methods, and systems, can be used to determine when it is most advantageous to perform quantitative or quantitative analytical procedures. For example, a liquid protein formulation is often prone to aggregation and the concentration of aggregates is routinely assessed using Size Exclusion Chromatography (SEC). Practitioners typically incubate the protein formulation under some stressor, such as temperature, agitation, or exposure to certain chemicals, and then intermittently make measurements of the concentration of undamaged protein and aggregates. During incubation, however, there is normally no way of knowing whether, when and how fast aggregation may be occurring, and therefore there is no rational means of determining when to make SEC measurements. The current invention provides both a continuous and quantitative means of determining when it is most advantageous to make SEC and/or other analytical measurements, and a ready source of incubated material for such analyses. The invention can also be used to automatically and intelligently control sample throughput on a light scattering detection device and various sample testing devices. Applicability to other macromolecules, both of synthetic and natural origin, is envisioned.

Currently, Gel Permeation Chromatography (GPC) also termed Size Exclusion Chromatography (SEC) is a standard method for determination of the concentration of protein aggregates and undamaged, native protein content in a protein solution. While SEC technically separates macromolecules due to a purely entropic mechanism based on the size of macromolecules, GPC is used to indicate any time macromolecular separation columns are used to separate macromolecular populations, even if there are enthalpic effects in addition to entropic effects involved in the separation. GPC is hence a more general term, but SEC and GPC are often used interchangeably. Here, GPC will be used. Typically, protein formulations are incubated under different stressors, such as temperature, agitation, exposure to interfaces, metals, oils, chemical agents, and then GPC analysis is intermittently performed. For GPC analysis, a small quantity, typically from about 10 to about 100 microliters is injected into a tube and a high pressure pump drives the protein containing material through an SEC column, which essentially separates the aggregate population from the native protein population. Sometimes more than one column is used. Such columns are available from companies such as Tosoh Corporation (e.g. G-3000 WSXL, TSK gel, 08541), Polymer Standard Services, Phenomenex, Shodex™, and others. Typically, a concentration detector such as an ultraviolet absorption detector, operating in the vicinity of 280 nm, which is the absorption region for the amino acids tryptophan, and to a lesser extent, tyrosine, and/or a refractive index detector, traces out chromatographic peaks corresponding to the aggregate and native (undamaged) protein populations. The areas under these peaks are determined, from which the concentrations of aggregate and undamaged protein can be calculated.

Such stressor and GPC studies, however, currently have no rational means of knowing when it is worthwhile to make the GPC measurements. Thus, researchers will usually simply guess at which point in the incubation period it might be worthwhile to make measurements, often using arbitrary schedules dictated by work flow requirements, convenience, or by educated guesses based on experience. Unless aggregation is very slow, GPC does not furnish detailed kinetics of the aggregation, since the cycle time for a GPC measurement is typically between ten minutes to an hour. If the aggregation is slow, it is possible to gather enough data points to elucidate some of the kinetics. Hence, intermittent sampling risks over-sampling, where GPC measurements are made needlessly because aggregation is very slow, or under-sampling, where aggregation has already progressed very far before GPC measurements are made. In either case, it is unusual to obtain enough kinetic information to determine what the mechanisms of the aggregation are, and when aggregation may switch from one mechanism to another during the process or under different stressors.

Simultaneous Multiple Sample Light Scattering (SMSLS) is a commercial platform that allows absolute light scattering measurements to be made under a variety of physical and chemical conditions for many independent samples. The developer and manufacturer of SMSLS is Advanced Polymer Monitoring Technologies, Inc. (APMT, New Orleans, La.). A current SMSLS model from APMT includes 16 independent sample cell holders, each with its own laser light source and scattering detection, temperature control, stepper-motor controlled stirring, depolarized scattering capabilities, enhanced dynamic sensitivity range, ability to titrate samples during experiments, to withdraw material during experiments without interrupting measurements, to reciprocate sample liquid in and out of the scattering cells, and to expose samples to different materials and interfaces, such as glasses, metals, oils, plastics, and gases. The entire hardware control, data collection, processing and storage, and much of the analysis are performed directly within software incorporated in the SMSLS platform. There are no moving parts in the optical delivery and detection system which allows absolute measurements of light scattering to be made. Hence, in addition to monitoring dimensionless aggregation rates, the SMSLS platform can also be used for determination of absolute weight average molecular weight, M_{w}, as well as second, third and higher virial coefficients A₂, A₃, etc. In multi-angle detection embodiments it is also possible to obtain z-average mean square radius of gyration <S²>_{z}. While the current APMT version of SMSLS has 16 sample cell holders, a 32 sample cell holder system is envisioned. Furthermore, there is no fundamental limit to the number of sample cell holders an SMSLS system can have.

Because of the fully independent nature of each sample cell holder, each of the samples, contained within the 16 sample cell holders, can be simultaneously incubated under different stressors. For example, some samples, whether identical or different, can be held at different temperatures or subjected to different temperature rate changes; samples can be stirred at different rates, or not stirred at all; some samples may be exposed to gas/liquid interfaces, while some may have no gas/liquid interface at all; others may be in contact with different materials or substances; and yet others can be reciprocating through syringe or other pumps and exposed to different material stressors. Naturally, the samples can be related, such as having the same protein under different formulation conditions, or be entirely different proteins in early development. A particularly interesting feature of SMSLS is its ability to monitor aggregation over a very wide protein concentration range from about 10⁻⁶ to about 0.200 g/cm³. Higher and lower concentrations may also be possible. The samples in the various sample cell holders may also be entirely unrelated, such as proteins in some cells and synthetic or other biopolymers in other cells.

A major advantage of the independent nature of the SMSLS platform is that samples can be changed in and out of the instrument without interrupting or affecting the measurements of other samples in progress at that time. This can be extremely useful when there is high variability in aggregation rates among samples, which can frequently be the case. It is not uncommon to find seven orders of magnitude difference in aggregation rates among different temperatures for a given protein, different formulations having the protein, different proteins, or different formulation conditions. This means, for example, that a sample that aggregates significantly in ten minutes can be removed and replaced with another that might aggregate in ten hours, while another sample in another cell might take five days to aggregate significantly and so must be left undisturbed for days. In this way, the efficiency and throughput of aggregation studies can be optimized using the SMSLS platform. Since the SMSLS platform has increasingly sophisticated data gathering, databasing, and analysis capabilities, the present disclosure provides devices, methods, and systems to determine when a sample has significantly aggregated and automatically remove said sample and introduce another one in a sample queue, thereby forming an intelligent sample exchanger. Such automation may be accomplished with a robotic arm or other automatic sample transportation device.

In addition to protein solutions, the presently disclosed devices, methods, and systems are also well-suited to applications with other macromolecules, including synthetic and biological macromolecules, as well as with nanoparticles, polymer/nanoparticle hybrid materials, and colloids. An example would be in degradation studies of polymers where these are kept under a stressor, such as temperature, and sampled intermittently and analyzed by GPC or other methods. An example is the degradation of a commercial polymer, such as Viton®, under heat stress in an organic solvent. Another example is the enzymatic degradation of a synthetic or biological polymer.

Another use of the present disclosure is where a dry macromolecular or colloidal material is dissolved and subsequent GPC or other analytical measurements are made. The devices, methods, and systems described herein allows the kinetics of dissolution to be monitored such that it will be quantitatively known when dissolution is complete and GPC or other analytical measurements can be made. Other analytical measurements in addition to GPC can include, but are not limited to: differential scanning calorimetry (DSC), thermal gravimetric analysis (TGA), pyrolysis, electron microscopy (EM), Matrix Assisted Laser Desorption Ionization (MALDI), Nuclear Magnetic Resonance (NMR), electron spin resonance (ESR), isothermal titration calorimetry, zeta potential determination by dynamic and/or electrophoretic light scattering, circular dichroism (CD), polarimetry, circular birefringence, mass spectroscopy by magnetic, Fourier, Time-of-Flight (TOF), and other means, fluorescence, viscometry, and ultracentrifugation.

Yet another use of the presently disclosed devices, methods, and systems is to monitor nano- or micro-crystallization of a sample in vitro. Here, the time course of the light scattering from samples can be used to schedule withdrawal of the sample for such measurements as DSC or X-ray diffraction to elucidate crystal structure. This could be particularly useful in the important area of protein crystallization carried out extensively in the proteomics and biotechnology sectors.

Further uses of the presently disclosed devices, methods, and systems include, but are not limited to, scheduling of measurements during time dependent processes in macromolecular and colloidal solutions such as aggregation, degradation, dissolution, coalescence, reversible associations, phase separation, phase changes, formation of sub-micron and micron size particulates.

The methods described herein are not restricted to any particular solvents or solvent systems. While aqueous solvents are most widely used with proteins, other solvents can be used such as, but not limited to, alcohols, toluene, acetone, chloroform, tetrahydrofuran, butyl acetate, dimethyl sulfoxide, di- and tri-chlorobenzene, carbon disulfide, benzene, octane, dimethyl formamide, N-methyl pyrollidinone, and others.

The invention is directed to a novel use of the SMSLS platform. The SMSLS platform already exists in a commercial embodiment but, prior to the present disclosure, has mainly been used for monitoring and analyzing changes in macromolecular solutions, rather than as a basis for scheduling subsequent activities, such as when a portion of the sample can be withdrawn for measurement of another type; e.g. by GPC, or for scheduling automatic sample exchange. The presently disclosed devices, methods, and systems are further described according to the following example application.

Assessment of the stability of a particular protein under different formulation conditions, which can include varying the pH, ionic strength, type of buffer, and excipient composition, such as surfactants (for example, Polysorbate), amino acids (for example, arginine), and sugars (for example, polysaccharides) may be desired. To achieve a rapid assessment of stability rather than simply maintaining the protein formulations at ‘pharmaceutically interesting temperatures’—e.g. 37° C., 4° C., −4° C., −20° C., and −70° C.—it is decided to also test the various formulations at higher temperatures, as is common in the industry. A series of test temperatures might include, for example, and in no way limiting, 15° C., 25° C., 37° C., 45° C., 50° C., 55° C., 60° C., and 70° C. With eight temperatures selected in this example it is possible to test two different formulations in a 16-cell SMSLS unit.

In the context of freezing protein formulations, freeze/thaw cycles are a frequent procedure in the pharmaceutical and biotechnology sectors, and the scheduling provides a means of assessing how these cycles may affect protein aggregation. Freezing can be performed onboard in the SMSLS, using Peltier or other freezing elements, and the scattering before and after is monitored to see the effects of one or more freeze/thaw cycles. This can be repeated, manually or automatically, as many times as desired, and the scattering signals for each cycle can provide information on the aggregation state and whether certain further analytical tests, such as GPC, should be performed. The freeze/thaw cycles can also be performed remotely from the scattering unit, such as in a cryogenic freezer, wherein the sample is measured in the scattering device before and after each cycle.

After the protein samples are prepared, they are placed in their respective SMSLS sample cell holders under the desired stressor conditions or no stressor conditions, and automatic collection of the light scattering from each begins. If the cells have been calibrated with toluene or another standard material (e.g. a molecular weight standard, such as from Polymer Standard Services, Amherst, Mass.) then absolute weight average molar mass of the protein material can be monitored in addition to the dimensionless aggregation state, defined as M_{w}(t)/Mₒ where Mₒ is the initial M_{w} of the solution (if there is no aggregation at the outset of the measurements then Mₒ corresponds to the monodisperse molar mass of the native protein).

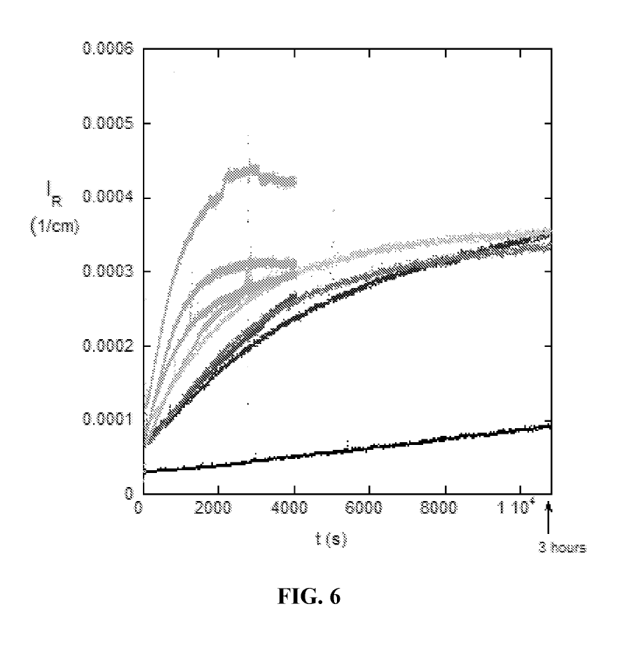

In a typical biotechnology scenario, incubation of the samples may be performed approximately three hours before making the first GPC measurements. FIG. 6 illustrates a monoclonal antibody (mAb) at concentrations ranging from 5 mg/ml to 120 mg/ml was incubated at 50° C. for three hours. This particular mAb has self-limiting aggregation; that is, it aggregates up to a certain extent and then stops, which can be seen by a plateau in the absolute light scattering (Rayleigh Scattering Ratio) shown versus time (in seconds). The most concentrated samples were removed before three hours, since their plateaus were reached. After three hours, a GPC analysis of aggregation will show that all but the lowest concentration sample have reached their maximum aggregation state. One might also conclude that, since all but one reached their plateau, that the aggregation rate is independent of protein concentration—a very erroneous conclusion, as is obvious from the graph. If it was assumed that the aggregation rate is linear, the error would be compounded, as aggregation out to three hours is clearly non-linear except for the lowest concentration.

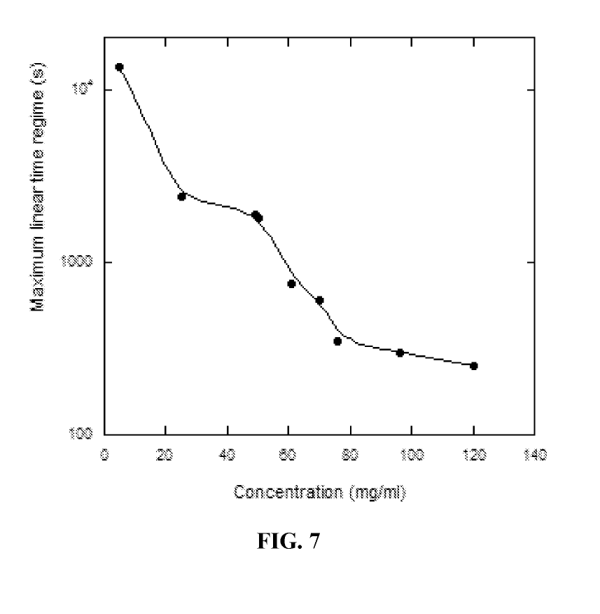

FIG. 7 shows the maximum amount of time that the aggregation profile versus time can be considered linear. It varies by almost two orders of magnitude, from a mere 200 seconds at the highest concentration to 14,000 seconds at the lowest concentration. The curved line through the data points are a guide for the eye. These data could be used in real-time to make decisions about when to perform GPC analyses on the samples, either manually or automatically. The supervising monitoring software, for example, can detect when non-linearity begins by continuous linear fitting until a parameter of goodness of fit, such as the frequently used correlation parameter R, reaches a maximum. Hence, the presently disclosed devices, methods, and systems can also be used to intelligently determine the regime over which aggregation is linear over time.

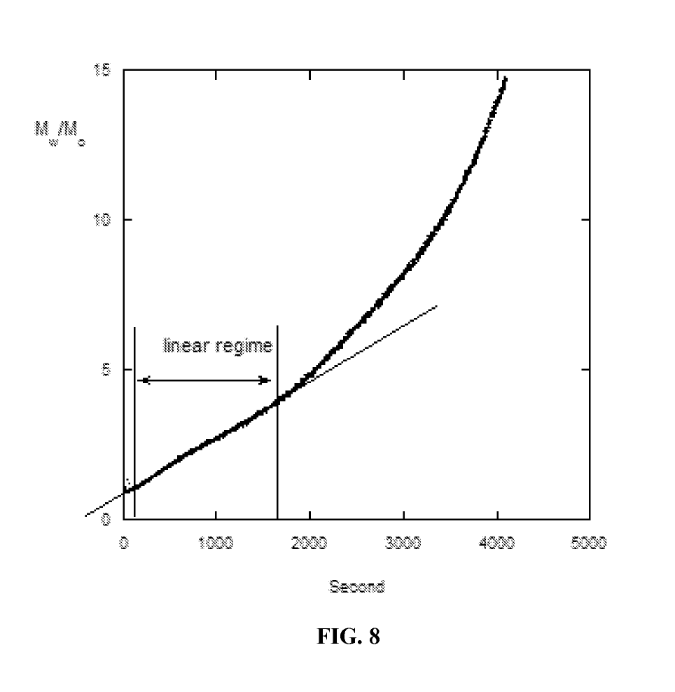

In another example, FIG. 8 illustrates typical aggregation data from SMSLS for a mAb. It is shown as M_{w}/Mₒ. The linear aggregation rate, AR, is defined as the slope over the linear regime

$$AR ( {s}^{- 1} ) \frac{d ( {M}_{W} / {M}_{0} )}{dt} . \qquad Eqn . 1$$

FIG. 8 illustrates the linear regime of the aggregation of the monoclonal antibody. As depicted in FIG. 8, the aggregation becomes increasingly non-linear and concave upwards after this regime.

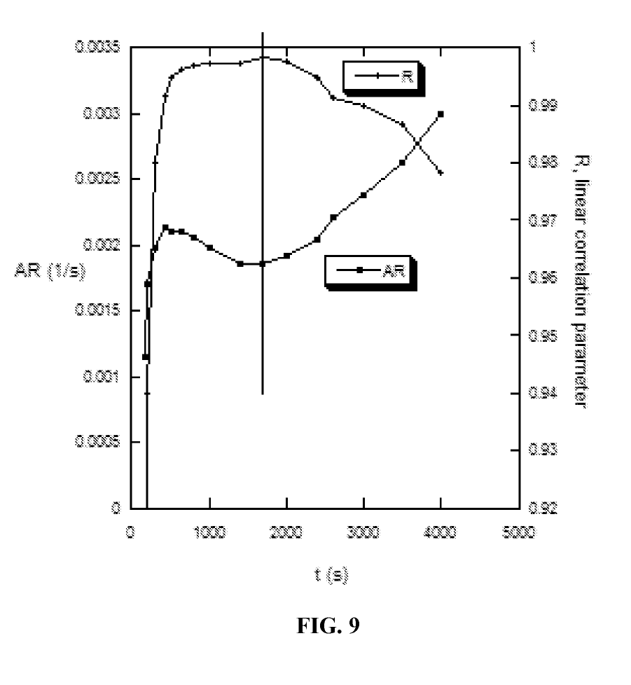

FIG. 9 illustrates both the AR and the linear correlation coefficient R versus time for the aggregation of the monoclonal antibody. The end of the linear regime is defined as the point in time of maximum R. After this, R decreases, the fitting quality declines, and the non-linear regime is entered.

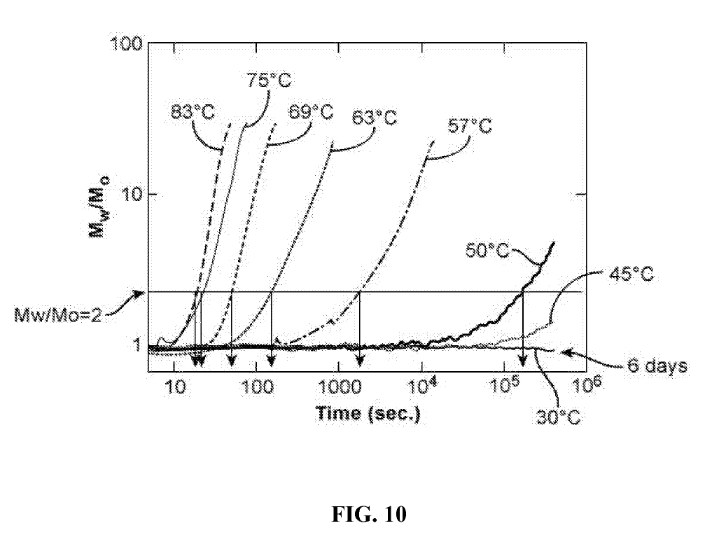

Another example is illustrated in FIG. 10. FIG. 10 illustrates the aggregation of a monoclonal antibody (mAb) at different temperatures for up to six days. All samples were characterized by a monoclonal antibody concentration of 10 mg/ml. The aggregation of this monoclonal antibody (mAb) is unlimited, and leads to precipitation after the steep climb in aggregation. The effect of temperature is so strong that a logarithmic time scale is needed to fit all the data on a single figure. Likewise, the extent of aggregation is so varied that a logarithmic scale is used for M_{w}/Mₒ. If the analytical scheduling for this was done according to aggregation reaching a certain criterion, such as when M_{w}/Mₒ reaches 2—i.e. an average dimeric state—then the arrows in FIG. 10 indicate, on the time axis, when aliquots should be either automatically or manually withdrawn for analysis, such as, for example, by GPC.

A further feature of the present disclosure is that material needed for analysis can be obtained by withdrawing an aliquot from the any one of the samples being monitored in the light scattering detection device. This withdrawal can be performed manually or automatically, for example, with a robotic arm. This removal can also be made without disturbing or otherwise interrupting the light scattering measurements being made on the sample. It is also possible to make multiple withdrawals from the same sample over time without disturbing or otherwise interrupting the light scattering measurements being made on the sample.

The use of the presently disclosed device, method, and system to determine the scheduling of sample withdrawal for subsequent measurement, such as injection into a GPC system, constitutes an intelligent autosampler. Current autosamplers work simply by having a queue of samples in a series, and these are sampled sequentially by an autosampler for analysis, such as by GPC. The presently disclosed device and system interprets the light scattering signals to determine which sample is next for measurement and will hence sample according to signal criteria, not simply by following a predetermined order of sampling.

The following example provides a demonstration of how many sample aliquots can be withdrawn from a single flow. A particular light scattering flow cell can hold approximately 3,700 microliters. The light scattering signature in the form of a predetermined time dependent solution characteristic measurement can signal an operator or robot when to obtain sample from the cell, and it might suggest many samples over time. For an analytical method such as GPC, up to 300 aliquots of 10 microliters each could be withdrawn without disturbing measurements in a current SMSLS system. Also available are cells that can use 50 microliters or less. From these, it will be possible to make one or two aliquot withdrawals without disturbing the ongoing measurements.

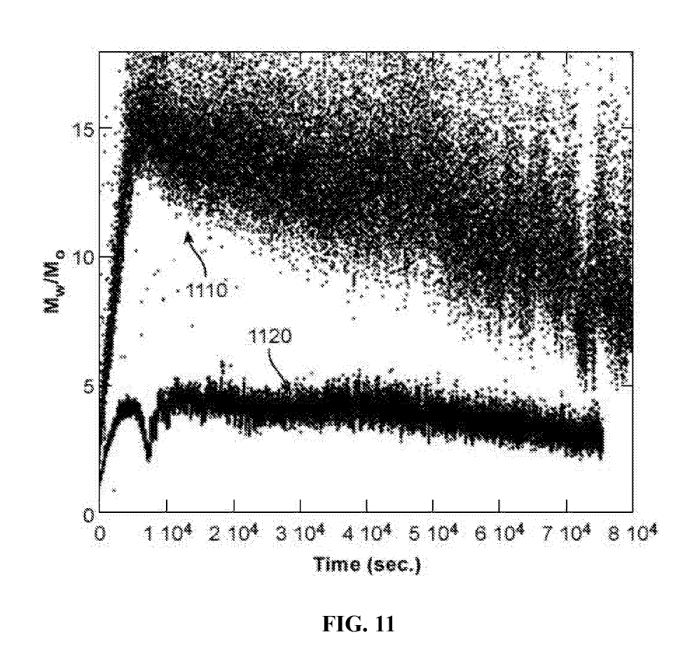

The light scattering signals can be used to discern when sub-micron and micron size particulates begin to form and how they evolve. This can be used to schedule an activity such as removing a stressor, continuing application of the stressor so as to further the particulation, withdrawing sample so as to make measurements such as with Mie scattering, EM, X-ray diffraction, DSC, and others. An example of ‘particulation’ is shown in FIG. 11. FIG. 11 depicts data for the same protein samples under two different conditions, where one, labeled 1110, is stirred at T=30° C. at 1,000 RPMs, and the other 1120 is unstirred but held at the elevated temperature of 48° C. Especially heavy particulation followed by slow precipitation occurs for the stirred sample after about one hour.

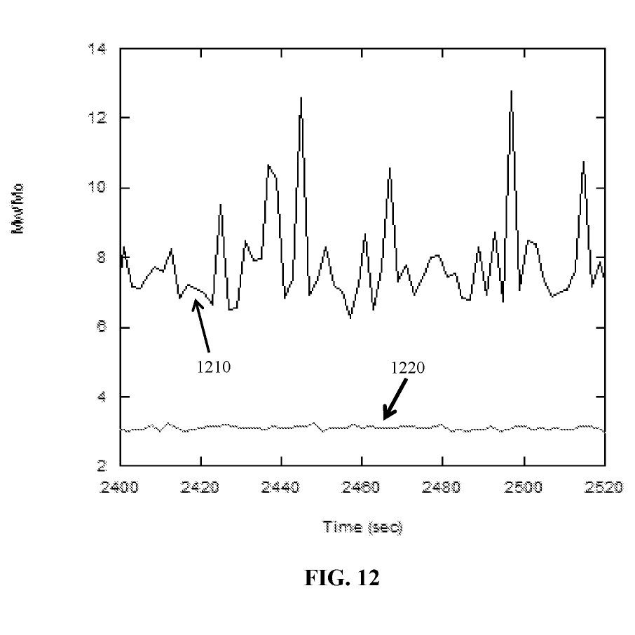

As depicted in FIG. 11, the particulation is detected by what looks like heavy noise in the scattering due to the passage of large colloid particles (greater than 200 nm diameter) through the scattering volume of the cell, and causing a large light scattering spike (LSS). The scattering volume is that portion of the incident laser beam in the scattering cell from which light reaches the detector. This can be seen in the 120 second swath excerpted from the same data and displayed in FIG. 12. The individual LSS are large and pronounced in the stirred sample, labeled 1210, whereas they are virtually non-existent in the 120-second swath for the heated sample 1220.

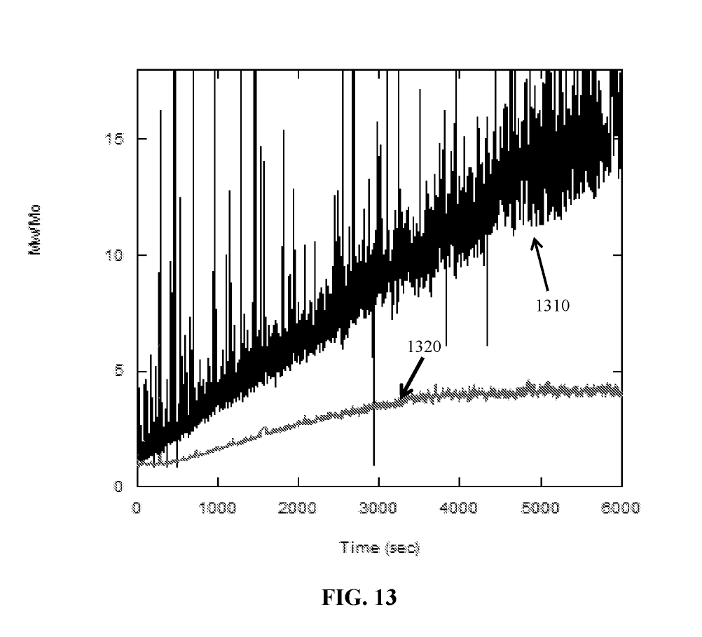

The sample heated to 48° C. takes longer to begin particulation and it is not as extensive, as seen in FIGS. 11-12, and even more so in FIG. 13. As shown in FIG. 13, the stirred sample 1310 begins to particulate immediately, whereas the sample heated to 48° C. 1320 has far less particulation over this time period.

According to another example an application of the present disclosure SMSLS data was used to decide when to schedule injections for GPC analysis. An Argen 16 cell SMSLS instrument produced by Advanced Polymer Monitoring Technologies, Inc. (New Orleans, La.) was used in this example application. The predetermined time dependent characteristic criterion for aliquot removal for GPC injection was that a measurable amount of change should occur in the light scattering signal in order to make the next injection.

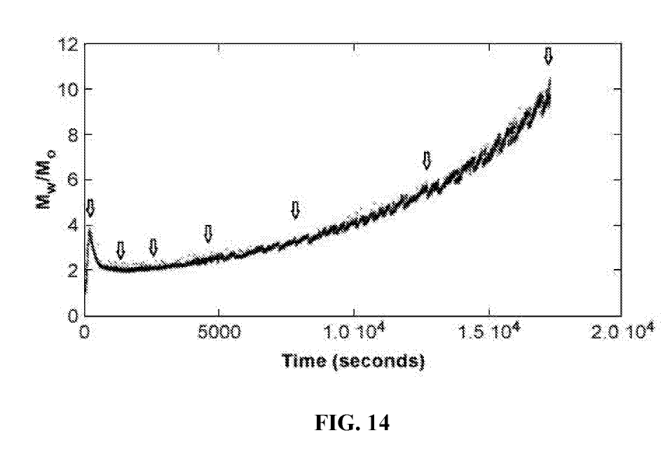

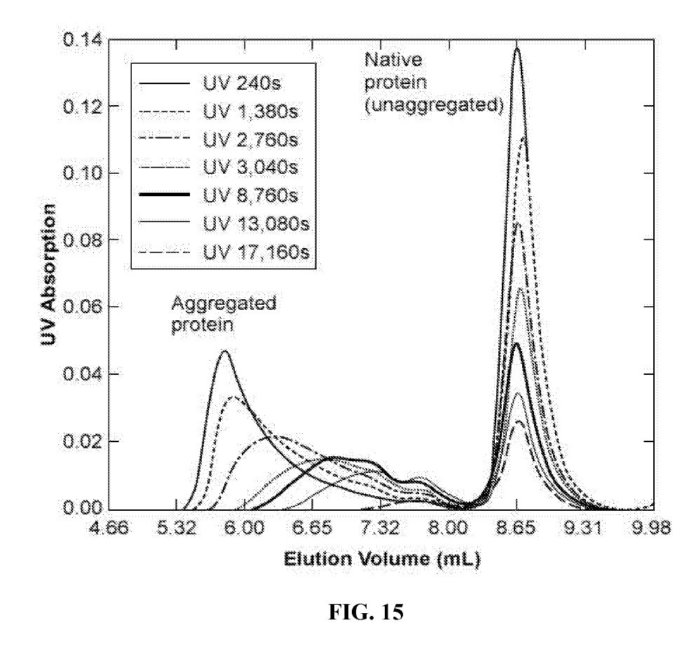

FIG. 14 illustrates an example removal of aliquots from a macromolecular solution sample based on a predetermined time dependent characteristic criterion. A monoclonal antibody (a protein) in a formulation was monitored by an SMSLS instrument at T=70° C. The protein concentration was 1 mg/ml. The left hand axis is M_{w}/Mₒ, where M_{w} is the weight average molecular weight of all native and aggregated protein at any time and Mₒ is the weight average at t=0, just before raising the temperature to T=70° C. The GPC data in FIG. 15 illustrates that Mₒ for this lot of protein had no aggregates at t=0. The arrows in the FIG. 14 show the points at which aliquots were withdrawn from the sample cell for GPC injection. The sample cell held 3.7 cm³ of sample and 0.1 cm³ was withdrawn for each GPC injection. Since this particular cell (square cell of borosilicate glass 1 cm on each side) in the SMSLS system can use as little as 0.6 cm³, up to 31 aliquots for analysis by GPC or any other instrument could be removed without affecting the cell's ability to continue making uninterrupted measurements. It is seen in FIG. 14 that there is no perturbation or interruption in the M_{w}/Mₒ signal at the arrows, where the aliquots are physically withdrawn from the sample cells. It is noted that the first arrow is on a peak which subsides subsequently before M_{w}/Mₙ then begins to rise monotonically for the rest of the monitoring period. This minor peak is due to a transient colloidal instability in the buffer which contained polysorbate 80, a surfactant that can show a transient association under heating. The transient has entirely disappeared by 1,000 s and the M_{w}/Mₙ rise thereafter is due to the protein aggregation process.

The GPC system used an Ultra SW Aggregate column from Tosoh Corporation (King of Prussia, Pa.), a Shimadzu High Pressure Liquid Chromatography pump, a Shimadzu SPD10AV Ultraviolet absorption spectrometer (UV) operating at 270 nm, and a Brookhaven Instruments BI-MwA 7 angle static light scattering detector. The flow rate was 0.8 mL/minute.

FIG. 15 shows the GPC UV data versus elution volume for aliquots removed from the protein aggregating at T=70° C. according to the arrows in FIG. 14. The UV absorption is directly proportional to the concentration (g/cm³) of the protein. The native protein peak is around 8.65 mL, and the aggregate peak first appears around 7.65 mL and broadens with the peak shifting to lower volumes as aggregates increase in size over time. The peak for the largest aggregates after several thousand seconds at T=70° C. is at 5.79 mL. As time at T=70° C. increases, the native protein peak decreases as proteins unfold and aggregate, leading to the increase in height, broadening, and shifting of the protein peak to lower elution volumes. In GPC the largest masses elute from the column first, and the smallest last, hence the aggregate peak is at low elution volume and the native peak at high elution volume. By 17,160 s most of the protein is in aggregated form.

The useful separation and progression of the aggregation process based on the SMSLS scheduling from FIG. 14 shows the value of this application of the presently disclosed devices, methods, and systems, and how it increases the usefulness of the GPC method. Without the presently disclosed devices, methods, and systems, there would be no notion of when and how often to schedule GPC analysis, leading to far less usefulness of the GPC method.

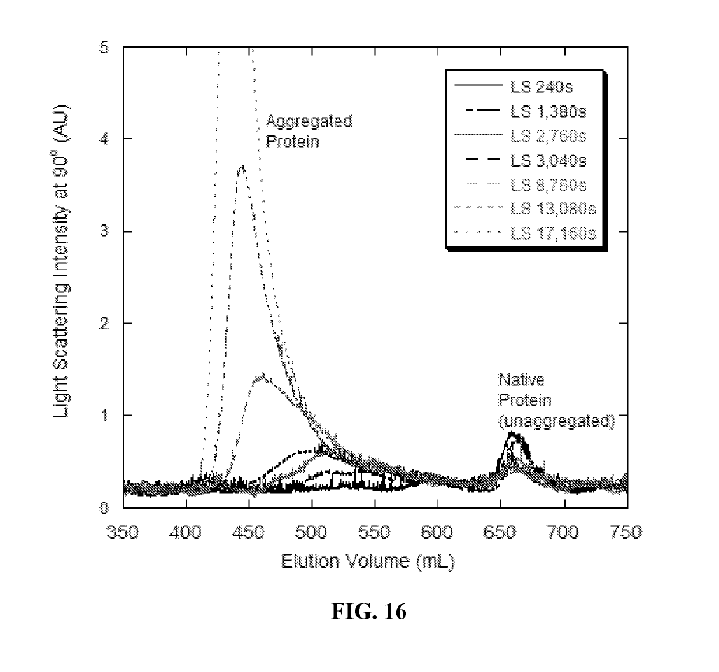

FIG. 16 shows the corresponding light scattering data at 90° scattering angle for the same GPC injections as in FIG. 15. Whereas the UV signal of FIG. 15 is proportional to protein concentration, the light scattering (LS) signal is proportional to concentration multiplied by protein molecular weight. Hence, the LS data emphasize the massiveness of the proteins, so that the aggregates, which are massive, have much higher LS than (unaggregated) native protein.

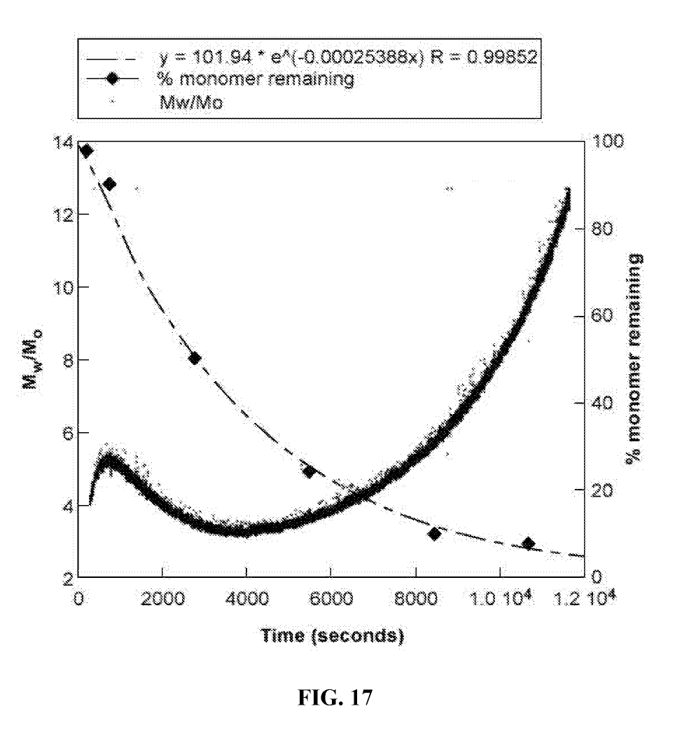

FIG. 17 shows how GPC data can be translated back into further analysis of SMSLS data. After using SMSLS scheduling to determine useful GPC analysis, the areas under UV peaks for aggregates and native proteins can be measured, from which their ratio is the ratio of aggregate concentration to the native protein concentration is directly found. This latter method of area ratio is commonly used in protein aggregation studies by GPC, but here the SMSLS scheduling has led to the most effective use of GPC.

Now, plotting the % of aggregates, by mass, in the solution versus time yields the data in FIG. 17, together with an exponential fit. The rate constant for the buildup of aggregate concentration is 0.000254 s, which means that the solution has 50% aggregate concentration after 2,800 s at T=70° C. Using this exponential function for aggregate concentration allows the SMSLS data to be further interpreted. Namely it allows for computing the molecular weight of the aggregates by separating out the concentration of aggregates and native protein using the exponential function. The use of an exponential function is not limiting, and any functional form that is appropriate, whether of an analytical or numerical form, such as spline and smoothing fits, can be used to describe the time dependence of the concentration of aggregates.

Also shown in FIG. 17 is M_{w}/Mₒ for the same protein as in FIGS. 14-16, albeit in a different buffer solution. The buffer also contains Polysorbate 80 so the temperature-induced colloidal transient seen in FIG. 14 is also seen.

Mass balance lets the time dependent concentration of native proteins, or ‘monomers,’ and aggregates, Cₘ(t) and Cₐ(t), respectively be summed to the initial known monomer concentration C_{m,0}:

C_{m,o}=Cₘ(t)+Cₐ(t). Eqn. 2

And, since the ratio of Cₘ(t)/Cₐ(t) is known at each instant from the fit to the GPC data, both Cₘ(t) and Cₐ(t) are known at each point in time.

The solvent background subtracted time dependent excess Rayleigh scattering ratio I_{R}(t) can be directly monitored by SMSLS. The method by which I_{R}(t) has can be extracted from SMSLS or any static light scattering measurement is amply known, for example, M. F. Drenski, W. F. Reed, “Simultaneous Multiple Sample Light Scattering for Characterization of Polymer Solutions”, J. App. Polym. Sci., vol. 92, 2724-2732, 2004. Use of toluene, for example, whose absolute Rayleigh scattering ratio is known as a function of temperature and incident wavelength can be used to obtain the solvent background subtracted time dependent excess Rayleigh scattering ratio I_{R}(t). Molecular weight standards, such as are used in GPC can also be used to calibrate light scattering instruments, such as SMSLS. I_{R}(t) is the sum of scattering particle subpopulations

$${I}_{R} ( t ) = {\sum }_{i = 1}^{∞} {K}_{i} {C}_{i} {M}_{i} . \qquad Eqn . 3$$

M₁ is the mass of the native protein (monomer), Cᵢ is the concentration of each scatterer (C₁ is the concentration of native protein, C₂ of dimers, etc.). Kᵢ is an optical constant defined for vertically polarized incident light, for each subpopulation i, by

$${K}_{i} = \frac{{( 2 π n )}^{2} {( \partial n / \partial {C}_{i} )}^{2}}{{N}_{A} {λ}^{4}} , \qquad Eqn . 4$$

where n is the index of refraction of the solvent, λ is the vacuum wavelength of the incident light, N_{A} is Avogadro's number and ∂n/∂C, is the differential index of refraction of component i in the solvent. Making the simplifying assumption that (∂n/∂Cᵢ)=0.186 cm³/g for the native protein and all aggregates allows Kᵢ to be taken out of the summation. The usual Zimm expression within the Rayleigh-Debye approximation can be used:

$$\frac{{KC}_{m , o}}{{I}_{R} ( t )} = \frac{1}{{M}_{w} ( t )} ( 1 + \frac{{q}^{2} {〈 {S}^{2} ( t ) 〉}_{z}}{3} ) + 2 〈 {A}_{2} ( t ) 〉 {C}_{m , o} + … , \qquad Eqn . 5$$

where M_{w} is the weight average molar mass of all scatterers in the solution, <S²>_{z} is the z-average mean square radius of gyration of the scattering population, <A₂> is a complex double average over the second virial coefficients A₂ (often termed B₂₂ in the literature) between particles interacting in two-body collisions, and q is the magnitude of the scattering vector given by

$$q = \frac{4 π n}{λ} sin ( θ / 2 ) , \qquad Eqn . 6$$

where θ is the angle of the scattering detector in the plane. Two important simplifying assumptions can be further made when SMSLS detection is at a single angle (90° in the current prototype). First, for native proteins and dense aggregates the dimension is typically <<100 nm, so that q²<S²>/3<<1 for particles smaller than this root mean square radius in water (n=1.33) and for λ=660 nm, where water and this wavelength are not limiting.

Secondly, <A₂> is normally on the order of 10⁻⁴ to 10⁻⁵ cm³-Mole/g² for proteins in equilibrium. For native proteins of M˜10⁵ g/Mole, and concentrations C_{m,o}˜0.001 g/cm³, such as used in this work the term 2A₂C_{m,o}M˜0.02, for A₂˜10⁻⁴ cm³-Mole/g²; i.e. A₂ has less than a 2% effect on determination of M_{w}(t) under these conditions. Hence, the approximation can be used that the total I_{R}(t) is the sum of the scattering from each sub-population I_{R,I} according to the form:

$$\frac{{I}_{R} ( t )}{K} = {\sum }_{i = 1}^{∞} {C}_{i} {M}_{i} = {C}_{m} ( t ) {M}_{1} + {\sum }_{i = 2}^{∞} {C}_{i} ( t ) {M}_{i} = {C}_{m} ( t ) {M}_{1} + {C}_{a} ( t ) {M}_{w , a} ( t ) , \qquad Eqn . 7$$

where M_{w,a}(t) is the weight average molar mass of all the aggregates in the solution at any time. Hence, knowledge of Cₘ(t) furnished by combined GPC and SMSLS allows M_{w,a}(t) to be found. M₁, the molecular weight of the protein is normally well known from its genetically determined primary amino acid sequence. Alternately, it can be measured by SMSLS at t=0 if no aggregates are present.

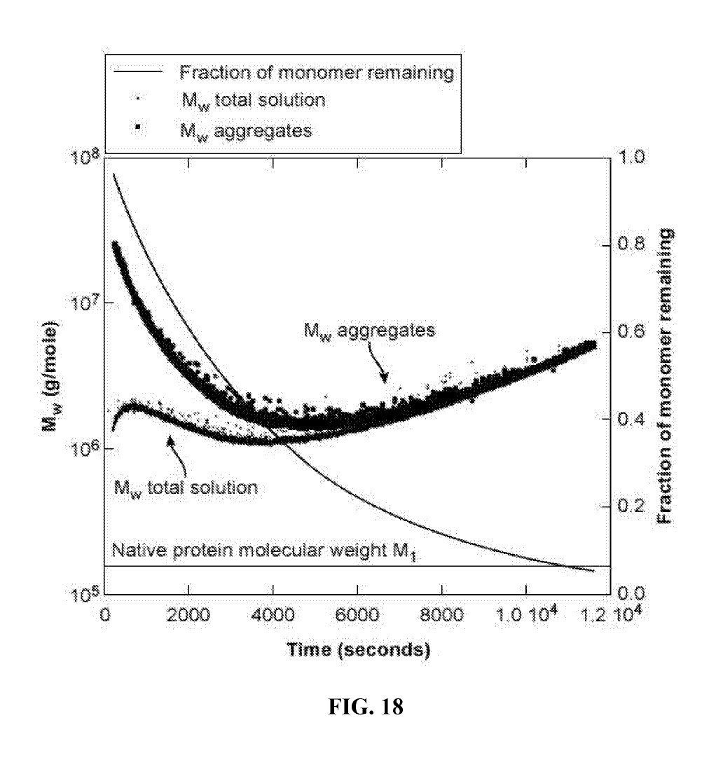

FIG. 18 makes these computations for the data and exponential fit from FIG. 17. M₁ of the monomer of 147,000 g/mole is constant in FIG. 18, whereas the total M_{w} from all scatterers in the solution is shown, and M_{w,a}(t) for the aggregates separated out. The colloidal aggregate contributes to the original decrease in M_{w,a}(t), and the increase in M_{w,a} due to protein aggregates commences around 4,000 s. As time progresses the protein aggregates dominate the scattering and after about 8,000 s virtually all the scattering from the solution is due to the protein aggregates. As seen, these are quite massive, with M_{w,a}=6×10⁶ g/mole, or about 50× more massive than the native protein.

The detailed analysis here is made possible by first using the presently disclosed devices, methods, and systems to schedule GPC measurements at effective time intervals, from which the subsequent GPC measurements then make possible separation of concentrations of native protein and aggregates, which allows return to the SMSLS data and to separate native protein scattering from aggregate scattering in order to compute the molecular weight of the aggregates.

The molecular weight and size of protein aggregates is critically important in the biotechnology and pharmaceutical sectors that develop biologic drugs, because particles arising from the biologic drugs that reach sizes of hundreds of nanometers and more can become antigenic, provoking both strong immunogenic and allergic responses in patients and immunity to the drug itself. The U.S. Food and Drug Administration is currently intensively seeking to understand the detrimental effects of aggregation in biologic drugs, so as to regulate these latter, and the U.S. National Institutes of Science and Technology is attempting to characterize aggregates produced by biologic drugs.

Several observations concerning the present disclosure are made in conjunction with these data. First, large particulates can plug and damage expensive GPC columns. The data here show that scheduling any GPC injection for the stirred sample could cause damage to the GPC system, whereas for the heated sample there is a window of about two hours in which GPC analysis could be performed without risk to the GPC system.

Second, making several GPC measurements during these two hours could give valuable data on aggregate concentration that can be combined with the SMSLS data to make important analysis and deductions concerning the kinetics and mechanisms of the aggregation phenomenon. It is pointed out that a weakness of SMSLS is that, while it furnishes M_{w} of the entire protein content, including native and aggregated proteins, it does not separate out the concentrations of material in native and aggregate form. With the knowledge of aggregate concentration (g/cm³), it is possible to compute the time course of the M_{w} of the aggregates themselves, yielding data directly on mechanisms of aggregation such as, for example, whether the aggregates reach and maintain a specific size, whether aggregates can stick to each other, or only add one damaged protein at a time. The data here show that, even without knowing the aggregate concentration from an auxiliary GPC or other measurement, the mechanisms of aggregation for stirring and heating are quite different. Under stirring, large scale aggregation begins immediately and yet the overall aggregation is linear up until the point where massive particulation begins, followed by relatively rapid precipitation. Under heating at 48° C., there is very little particulation initially and the aggregation process is self-limiting before particulation and very slow precipitation begin.

Third, if it were desired to make analytical measurements while in the linear phase of aggregation it is seen that for the sample heated to 48° C. non-linearity begins around 1,800 seconds. The stirred sample exhibits linearity until about 6,000 seconds, but has significant particulation. This would allow for scheduling any measurements desired in the linear regime.

Fourth, if the objective were to study the aggregates themselves, for example with EM, DSC, X-ray diffraction, Mie scattering, electrophoretic scattering, dynamic light scattering, any number of particle sizing methods, including video sizing and light occlusion sizing, or any other method, then the data can provide a guide for making a scheduling decision, showing how the concentration and relative size of the particulates changes in time. The scheduling decision can include, for example, when to obtain a sample from a sample cell for quantitative or qualitative analysis, and when to remove a sample cell from a sample cell holder containing a sample from the SMSLS system and place a new sample cell containing a new sample into the sample cell holder of the SMSLS for experimentation.

While the above figures have been described with some specificity above, persons of ordinary skill in the art will appreciate many variations to the actual system components and layout thereof and still remain within the scope of the present technology. The foregoing descriptions of specific devices, methods, and systems of the present disclosure have been presented for purposes of illustration and description. They are not intended to be exhaustive or to limit the disclosure to the precise devices, methods, and systems disclosed and obviously many modifications and variations are possible in light of the above teaching. The examples were chosen and described in order to best explain the principles of the disclosure and its practical application, to thereby enable others skilled in the art to best utilize the disclosure with various modifications as are suited to the particular use contemplated. It is intended that the scope of the disclosure be defined by the claims appended hereto and their equivalents.

Statements of the Disclosure Include:

Statement 1: A device comprising: a plurality of monitoring reservoirs, each monitoring reservoir configured to receive a macromolecular solution sample; a light scattering detection instrument coupled to the plurality of monitoring reservoirs, the light scattering detection instrument configured to monitor light scattering from a plurality of macromolecular solution samples received in the plurality of monitoring reservoirs; and a computing device coupled to the light scattering detection instrument, the computing device configured to measure a predetermined time dependent characteristic of one or more of the macromolecular solution samples based on the monitored light scattering at the light scattering detection instrument; wherein the computing device is further configured to determine a time for performing an operation on one or more of the plurality of macromolecular solution samples based on the predetermined time dependent characteristic measurement.

Statement 2: A device according to Statement 1, wherein the computing device is configured to determine a time for performing an operation on one or more of the macromolecular solution samples based on when a predetermined time dependent characteristic criterion is satisfied as monitored in time by light scattering measurements at the light scattering detection device.

Statement 3: A device according to Statement 2 or Statement 3, wherein the computing device is configured to generate a schedule for the quantitative or qualitative analytical testing of at least one of the plurality of macromolecular solution samples based on the measured predetermined time dependent characteristic.

Statement 4: A device according to any of the preceding Statements 1-3, wherein the computing device is configured to generate a schedule for the quantitative or qualitative analytical testing of a macromolecular solution sample based, at least in part, on the determined time for performing an operation.

Statement 5: A device according to any one of the preceding Statements 1-4, wherein the computing device is configured to generate a schedule for the quantitative or qualitative analytical testing of a macromolecular solution sample based on when a predetermined time dependent characteristic criterion is satisfied as monitored in time by light scattering measurements at the light scattering detection device.

Statement 6: A device according to any one of the preceding Statements 1-5, wherein the predetermined time dependent characteristic is protein aggregation.

Statement 7: A device according to any one of the preceding Statements 2-6, wherein the time dependent characteristic criterion is a predetermined value of M_{W}/M_{O}.

Statement 8: A device according to any one of the preceding Statements 3-7, wherein the schedule comprises a series of times for performing a corresponding series of intended operations on one or more macromolecular solution samples.

Statement 9: A device according to any one of the preceding Statements 3-8, wherein the schedule is generated based, at least in part, on a performance characteristic of the sample testing device.

Statement 10: A device according to Statement 9, wherein the performance characteristic is selected from the group consisting of: the number of samples awaiting testing at the sample testing device, the number and timing of analytical tests awaiting performance at the sample testing device, and the calculated delay in analytical testing of the sample at the sample testing device.

Statement 11: A device according to any one of the preceding Statements 1-10, wherein the operation is selected from the group consisting of: quantitative analytical testing, qualitative analytical testing, removing the macromolecular solution sample from the light scattering detection instrument, replacing the macromolecular solution sample at the light scattering detection instrument, introducing a stressor, transferring the macromolecular solution sample to a sample testing device, and transferring the macromolecular solution sample to a storage reservoir.

Statement 12: A device according to any one of the preceding Statements 1-11, wherein the light scattering detection instrument is configured to simultaneously monitor light scattering from two or more of the plurality of macromolecular solution samples received in the plurality of monitoring reservoirs.

Statement 13: A device according to any one of the preceding Statements 1-12, wherein the light scattering detection instrument is configured to monitor in series light scattering from the plurality of macromolecular solution samples received in the plurality of monitoring reservoirs.

Statement 14: A device according to any one of the preceding Statements 1-13, wherein the light scattering detection instrument is a simultaneous multiple light scattering (SMSLS) instrument.

Statement 15: A device according to any one of the preceding Statements 1-14, wherein the macromolecular solution samples are protein solutions.

Statement 16: A device according to any one of the preceding Statements 1-15, wherein at least one of the macromolecular solution samples comprises proteins undergoing crystallization.

Statement 17: A device according to any one of the preceding Statements 1-16, wherein at least one of the macromolecular solution samples comprises one or more of synthetic polymers, polysaccharides, nanoparticles, particle/polymer hybrids, natural products, and colloid particles.

Statement 18: A device according to any one of the preceding Statements 1-17, further comprising a plurality of stressor modules coupled to the plurality of monitoring reservoirs, the plurality of stressor modules configured to introduce a stressor to at least one of the macromolecular solution samples received in the plurality of monitoring reservoirs.

Statement 19: A device according to Statement 18, wherein each of the plurality of stressor modules is coupled to at least one of the plurality of monitoring reservoirs and each stressor module is respectfully configured to introduce a stressor to the macromolecular solution sample contained in at least one of the plurality of monitoring reservoirs.

Statement 20: A device according to Statement 18 or Statement 19, wherein the stressor is selected from the group consisting of: a change in temperature, agitation, shearing ultrasonication, stirring, exposure to a gas/liquid interface, exposure to a metal, exposure to an oil, exposure to a plastic, exposure to a glass, exposure to a ceramic, change in pH, change in ionic strength, change in buffer type, change in buffer strength, a surfactant, metal ions, sugars, polysaccharides, and amino acids.

Statement 21: A device according to any one of the preceding Statements 1-20, wherein the computing device is further configured to cause an operation to be performed on one or more of the plurality of macromolecular solution samples received in the plurality of monitoring reservoirs at the determined time for performing an operation.

Statement 22: A device according to any one of the preceding Statements 1-21, wherein the operation comprises removing at least a portion of the macromolecular solution sample from a respective one of the plurality of monitoring reservoirs or transferring the at least a portion of the macromolecular solution sample to a sample testing device.

Statement 23: A device according to any one of the preceding Statements 1-22, wherein the computing device is further configured to cause at least one macromolecular solution sample received in a respective one of the plurality of monitoring reservoirs to be replaced by a second macromolecular solution sample.

Statement 24: A device according to any one of the preceding Statements 1-23, further comprising a sample transfer device coupled to the computing device, the sample transfer device configured to transfer at least one macromolecular solution sample received in the plurality of monitoring reservoirs, or portion thereof, to an analysis reservoir configured to receive a macromolecular solution sample for analytical testing.

Statement 25: A device according to Statement 24, wherein the sample transfer device is configured to transfer a corresponding one of the macromolecular solution samples to the analysis reservoir at the time for performing an operation determined by the computing device for the corresponding macromolecular solution sample.

Statement 26: A device according to any one of the preceding Statements 1-25, wherein the computing device is further configured to generate a schedule for the quantitative or qualitative analytical testing of at least one of the plurality of macromolecular solution samples based on the measured predetermined time dependent characteristic, and wherein the sample transfer device is configured to transfer a corresponding one of the macromolecular solution samples to the analysis reservoir based on the generated schedule.

Statement 27: A device according to any one of the preceding Statements 24-26, wherein the computing device is configured to cause the sample transfer device to transfer a corresponding one of the macromolecular solution samples to the analysis reservoir at the time for performing an operation determined by the computing device for the macromolecular solution sample.

Statement 28: A device according to any one of the preceding Statements 1-27, wherein the computing device is further configured to generate a schedule for the quantitative or qualitative analytical testing of at least one of the plurality of macromolecular solution samples based on the measured predetermined time dependent characteristic, and wherein the computing device is configured to cause the sample transfer device to transfer a corresponding one of the macromolecular solution samples to the analysis reservoir based on the generated schedule.

Statement 29: A device according to any one of the preceding Statements 24-28, wherein the sample transfer device is selected from the group consisting of: a robotic device, a Cartesian robotic arm, a translatable stage, a rotary stage, an automated sample cell holder, and an intelligent autosampler.

Statement 30: A device according to any one of the preceding Statements 24-29, wherein the sample transfer device is configured to target a macromolecular solution sample received in the plurality of monitoring reservoirs using a specified coordinate system or axis-grid.

Statement 31: A device according to any one of the preceding Statements 24-30, wherein the sample transfer device comprises a hollow needle or pipette configured to extract fluid from one or more of the plurality of monitoring reservoirs.

Statement 32: A device according to any one of the preceding Statements 1-31, further comprising a sample testing device comprising at least one analysis reservoir configured to receive a macromolecular solution sample, or portion thereof, from the sample transfer device, the sample testing device configured to perform at least one analytical test on at least one macromolecular solution sample received in the at least one analysis reservoir.

Statement 33: A device according to any one of the preceding Statements 24-32, wherein the sample testing device is selected from the group consisting of: gel permeation chromatography (GPC) instrument, differential scanning calorimetry (DSC) instrument, thermogravimetric analysis (TGA) instrument, an X-ray diffractometer, ultracentrifuge, electron microscope, calorimeter, and video microscope.

Statement 34: A device according to any one of the preceding Statements 24-33, wherein the sample testing device is configured to perform at least one analytical test selected from the group consisting of: gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, ultraviolet absorption, video microscopy, video particle sizing, light occlusion particle sizing, and ultracentrifugation.

Statement 35: A device according to any one of the preceding Statements 32-34, wherein the analysis reservoir is an automated sample cell holder or an intelligent autosampler.

Statement 36: A device according to any one of the preceding Statements 32-35, wherein the analysis reservoir is a sample loop of a GPC configured to inject a macromolecular solution sample, or a portion thereof, into a GPC column.

Statement 37: A device according to any one of the preceding Statements 32-36, wherein the sample testing device is configured to perform a plurality of analytical tests on at least one macromolecular solution sample received in the analysis reservoir at predetermined time points determined by the computing device based upon the predetermined time dependent characteristic measurements.

Statement 38: A device according to any one of the preceding Statements 32-37, further comprising at least one storage reservoir configured to receive a macromolecular solution sample, wherein the sample transfer device is configured to transfer at least one macromolecular solution sample received in the plurality of monitoring reservoirs, or portion thereof, to the at least one storage reservoir.

Statement 39: A device according to any one of the preceding Statements 32-38, wherein the computing device is further configured to, upon determining a delay, cause the sample transfer device to transfer a macromolecular solution sample, or portion thereof, to the at least one storage reservoir based on the time for performing an operation determination.

Statement 40: A device according to Statement 39, wherein the at least one storage reservoir is an automated sample cell holder or an intelligent autosampler.

Statement 41: A method of scheduling analytical testing on a macromolecular solution comprising: monitoring, at a light scattering detection instrument, light scattering from two or more macromolecular solution samples; measuring, at a computing device, a predetermined time dependent characteristic of the two or more macromolecular solution samples based on the monitored light scattering at the light scattering detection instrument; and determining, at the computing device, a time for performing an operation on at least one of the two or more macromolecular solution samples based on a change in the predetermined time dependent characteristic measurement.

Statement 42: A method according to Statement 41, wherein determining comprises determining a time for performing an operation on one or more of the macromolecular solution samples based on when a predetermined time dependent characteristic criterion is satisfied as monitored in time by light scattering measurements at the light scattering detection device.

Statement 43: A method according to Statement 41 or Statement 42, further comprising causing, at the computing device, the performance of the operation on at least one of the two or more macromolecular solution samples at the determined time for performing the operation.

Statement 44: A method according to any one of the preceding Statements 41-43, wherein the operation is selected from the group consisting of: quantitative analytical testing, qualitative analytical testing, removing the macromolecular solution sample from the light scattering detection instrument, replacing the macromolecular solution sample at the light scattering detection instrument, introducing a stressor, transferring the macromolecular solution sample to a sample testing device, and transferring the macromolecular solution sample to a storage reservoir.

Statement 45: A method according to any one of the preceding Statements 41-44, further comprising generating a schedule for the quantitative or qualitative analytical testing of at least one of the two or more macromolecular solution samples based on the measured predetermined time dependent characteristic.

Statement 46: A method according to any one of the preceding Statements 41-44, further comprising generating a schedule for the quantitative or qualitative analytical testing of at least one of the two or more macromolecular solution samples based, at least in part, on the determined time for performing an operation.

Statement 47: A method according to any one of the preceding Statements 41-44, further comprising generating a schedule for the quantitative or qualitative analytical testing of at least one of the two or more macromolecular solution samples based on the measured predetermined time dependent characteristic.

Statement 48: A method according to any one of the preceding Statements 41-44, further comprising generating a schedule for the quantitative or qualitative analytical testing of at least one of the two or more macromolecular solution samples based on when a predetermined time dependent characteristic criterion is satisfied as monitored in time by light scattering measurements at the light scattering detection device.

Statement 49: A method according to any one of the preceding Statements 41-48, wherein the predetermined time dependent characteristic is protein aggregation.

Statement 50: A method according to any one of the preceding Statements 41-49, wherein the time dependent characteristic criterion is a predetermined value of M_{W}/M_{O}.

Statement 51: A method according to any one of the preceding Statements 41-50, wherein the schedule comprises a series of times for performing a corresponding series of intended operations on one or more macromolecular solution samples.

Statement 52: A method according to any one of the preceding Statements 41-51, wherein the schedule is generated based, at least in part, on a performance characteristic of the sample testing device.

Statement 53: A method according to Statement 52, wherein the performance characteristic is selected from the group consisting of: the number of samples awaiting testing at the sample testing device, the number and timing of analytical tests awaiting performance at the sample testing device, and the calculated delay in analytical testing of the sample at the sample testing device.

Statement 54: A method according to any one of the preceding Statements 41-53, wherein monitoring, at the light scattering detection instrument, comprises simultaneously monitoring light scattering from two or more macromolecular solution samples.

Statement 55: A method according to any one of the preceding Statements 41-54, wherein monitoring, at the light scattering detection instrument, comprises monitoring in series light scattering from two or more macromolecular solution samples.

Statement 56: A method according to any one of the preceding Statements 41-55, wherein the light scattering detection instrument is a simultaneous multiple light scattering (SMSLS) instrument.

Statement 57: A method according to any one of the preceding Statements 41-56, wherein at least one of the two or more macromolecular solution samples comprises one or more proteins.

Statement 58: A method according to any one of the preceding Statements 41-57, wherein at least one of the two or more macromolecular solution samples comprises one or more proteins undergoing crystallization.

Statement 59: A method according to any one of the preceding Statements 41-58, wherein at least one of the two or more macromolecular solution samples comprise one or more synthetic polymers, polysaccharides, nanoparticles, particle/polymer hybrids, natural products, and colloid particles.

Statement 60: A method according to any one of the preceding Statements 41-59, further comprising transferring, using a sample transfer device, at least one of the two or more macromolecular solution samples, or a portion thereof, to a sample testing device based on the generated schedule.

Statement 61: A method according to Statement 60, further comprising performing, at the sample testing device, a quantitative or qualitative analytical test on the transferred macromolecular solution sample.

Statement 62: A method according to any one of the preceding Statements 45-61, wherein the schedule comprises a plurality of predetermined times for quantitative or qualitative analytical testing of the same macromolecular solution sample, or a portion thereof.

Statement 63: A method according to any one of the preceding Statements 60-62, further comprising performing, at the sample testing device, a plurality of quantitative or qualitative analytical tests on the same macromolecular solution sample according to the schedule comprising a plurality of predetermined times.

Statement 64: A method according to any one of the preceding Statements 60-63, wherein the sample testing device is selected from the group consisting of: gel permeation chromatography (GPC) instrument, differential scanning calorimetry (DSC) instrument, thermogravimetric analysis (TGA) instrument, an X-ray diffractometer, ultracentrifuge, electron microscope, calorimeter, and video microscope.

Statement 65: A method according to Statements 63 or Statement 64, wherein the performing comprises at least one analytical test selected from the group consisting of: gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, video microscopy, ultraviolet absorption, video particle sizing, light occlusion particle sizing, and ultracentrifugation.

Statement 66: A method according to any one of the preceding Statements 41-65, further comprising replacing, at the light scattering detection instrument, at least one of the two or more macromolecular solution samples with a new macromolecular solution sample based on the generated schedule.

Statement 67: A method according to any one of the preceding Statements 41-66, wherein the predetermined time dependent characteristic is the formation of particulates and the operation is particle characterization testing.

Statement 68: A method according to any one of the preceding Statements 41-67, wherein the predetermined time dependent characteristic is the formation of particulates and the operation is crystallinity testing by X-ray diffraction or differential scanning calorimetry (DSC).

Statement 69: A method according to any one of the preceding Statements 41-68, further comprising introducing, at a stressor module, a stressor to at least one of the macromolecular solution samples.

Statement 70: A method according to Statements 68, wherein the stressor is selected from the group consisting of: a change in temperature, agitation, shearing ultrasonication, stirring, exposure to a gas/liquid interface, exposure to a metal, exposure to an oil, exposure to a plastic, exposure to a glass, exposure to a ceramic, change in pH, change in ionic strength, change in buffer type, change in buffer strength, a surfactant, metal ions, sugars, polysaccharides, and amino acids.

Statement 71: A device comprising: a light scattering device configured to monitor light scattering from a plurality of macromolecular solution samples; and at least one processor in communication with the light scattering device, wherein the processor is coupled with a non-transitory computer readable storage medium having stored therein instructions which, when executed by the at least one processor, causes the processor to: measure a predetermined time dependent characteristic of the plurality of macromolecular solution samples based on the monitored light scattering at the light scattering detection instrument; determine a time for performing an operation on at least one of the plurality macromolecular solution samples based on a change in the predetermined time dependent characteristic measurement.

Statement 72: A device according to Statement 71, wherein the determine comprises determine a time for performing an operation on one or more of the macromolecular solution samples based on when a predetermined time dependent characteristic criterion is satisfied as monitored in time by light scattering measurements at the light scattering detection device.

Statement 73: A device according to Statement 71 or Statement 72, wherein the non-transitory computer-readable storage medium further contains a set of instructions that when executed by the at least one processor further causes the processor to: generate a schedule for the quantitative or qualitative analytical testing of at least one of the two or more macromolecular solution samples based, at least in part, on the determined time for performing an operation.

Statement 74: A device according to Statement 71 or Statement 72, wherein the non-transitory computer-readable storage medium further contains a set of instructions that when executed by the at least one processor further causes the processor to: generate a schedule for the quantitative or qualitative analytical testing of at least one of the two or more macromolecular solution samples based on the measured predetermined time dependent characteristic.

Statement 75: A device according to Statement 71 or Statement 72, wherein the non-transitory computer-readable storage medium further contains a set of instructions that when executed by the at least one processor further causes the processor to: generate a schedule for the quantitative or qualitative analytical testing of at least one of the two or more macromolecular solution samples based on when a predetermined time dependent characteristic criterion is satisfied as monitored in time by light scattering measurements at the light scattering detection device.

Statement 76: A device according to any one of the preceding Statements 71-75, wherein the predetermined time dependent characteristic is protein aggregation.

Statement 77: A device according to any one of the preceding Statements 71-76, wherein the time dependent characteristic criterion is a predetermined value of M_{W}/M_{O}.

Statement 78: A device according to any one of the preceding Statements 71-77, wherein the schedule comprises a series of times for performing a corresponding series of intended operations on one or more macromolecular solution samples.

Statement 79: A device according to any one of the preceding Statements 71-78, wherein the schedule is generated based, at least in part, on a performance characteristic of the sample testing device.

Statement 80: A device according to Statement 79, wherein the performance characteristic is selected from the group consisting of: the number of samples awaiting testing at the sample testing device, the number and timing of analytical tests awaiting performance at the sample testing device, and the calculated delay in analytical testing of the sample at the sample testing device.

Statement 81: A device according to any one of the preceding Statements 71-80, further comprising a sample transfer device, wherein the non-transitory computer-readable storage medium further contains a set of instructions that when executed by the at least one processor further causes the processor to: cause the transfer, using the sample transfer device, of at least one macromolecular solution sample, or a portion thereof, to a sample testing device based on the generated schedule.

Statement 82: A device according to any one of the preceding Statement 71-81, further comprising a sample testing device, wherein the non-transitory computer-readable storage medium further contains a set of instructions that when executed by the at least one processor further causes the processor to: cause the performance of a quantitative or qualitative analytical test on the transferred macromolecular solution sample using the sample testing device based on the generated schedule.

Statement 83: A system comprising: a plurality of monitoring reservoirs, each monitoring reservoir configured to receive a macromolecular solution sample; a light scattering detection instrument coupled to the plurality of monitoring reservoirs, the light scattering detection instrument configured to monitor light scattering from a plurality of macromolecular solution samples received in the plurality of monitoring reservoirs; and a computing device coupled to the light scattering detection instrument, the computing device configured to measure a predetermined time dependent characteristic of one or more of the macromolecular solution samples based on the monitored light scattering at the light scattering detection instrument; wherein the computing device is further configured to determine a time for performing an operation on one or more of the plurality of macromolecular solution samples based on the predetermined time dependent characteristic measurement.

Statement 84: A system according to Statement 83, wherein the computing device is configured to determine a time for performing an operation on one or more of the macromolecular solution samples based on when a predetermined time dependent characteristic criterion is satisfied as monitored in time by light scattering measurements at the light scattering detection device.

Statement 85: A system according to Statement 83 or Statement 84, wherein the computing device is configured to generate a schedule for the quantitative or qualitative analytical testing of at least one of the plurality of macromolecular solution samples based on the measured predetermined time dependent characteristic.

Statement 86: A system according to any of the preceding Statements 83-85, wherein the computing device is configured to generate a schedule for the quantitative or qualitative analytical testing of a macromolecular solution sample based, at least in part, on the determined time for performing an operation.

Statement 87: A system according to any one of the preceding Statements 83-86, wherein the computing device is configured to generate a schedule for the quantitative or qualitative analytical testing of a macromolecular solution sample based on when a predetermined time dependent characteristic criterion is satisfied as monitored in time by light scattering measurements at the light scattering detection device.

Statement 88: A system according to any one of the preceding Statements 83-87, wherein the predetermined time dependent characteristic is protein aggregation.

Statement 89: A system according to any one of the preceding Statements 84-88, wherein the time dependent characteristic criterion is a predetermined value of M_{W}/M_{O}.

Statement 90: A system according to any one of the preceding Statements 85-89, wherein the schedule comprises a series of times for performing a corresponding series of intended operations on one or more macromolecular solution samples.

Statement 91: A system according to any one of the preceding Statements 85-90, wherein the schedule is generated based, at least in part, on a performance characteristic of the sample testing device.

Statement 92: A system according to Statement 91, wherein the performance characteristic is selected from the group consisting of: the number of samples awaiting testing at the sample testing device, the number and timing of analytical tests awaiting performance at the sample testing device, and the calculated delay in analytical testing of the sample at the sample testing device.

Statement 93: A system according to any one of the preceding Statements 83-92, wherein the operation is selected from the group consisting of: quantitative analytical testing, qualitative analytical testing, removing the macromolecular solution sample from the light scattering detection instrument, replacing the macromolecular solution sample at the light scattering detection instrument, introducing a stressor, transferring the macromolecular solution sample to a sample testing device, and transferring the macromolecular solution sample to a storage reservoir.

Statement 94: A system according to any one of the preceding Statements 83-93, wherein the light scattering detection instrument is configured to simultaneously monitor light scattering from two or more of the plurality of macromolecular solution samples received in the plurality of monitoring reservoirs.

Statement 95: A system according to any one of the preceding Statements 83-94, wherein the light scattering detection instrument is configured to monitor in series light scattering from the plurality of macromolecular solution samples received in the plurality of monitoring reservoirs.

Statement 96: A system according to any one of the preceding Statements 83-95, wherein the light scattering detection instrument is a simultaneous multiple light scattering (SMSLS) instrument.

Statement 97: A system according to any one of the preceding Statements 83-96, wherein the macromolecular solution samples are protein solutions.

Statement 98: A system according to any one of the preceding Statements 83-97, wherein at least one of the macromolecular solution samples comprises proteins undergoing crystallization.

Statement 99: A system according to any one of the preceding Statements 83-98, wherein at least one of the macromolecular solution samples comprises one or more of synthetic polymers, polysaccharides, nanoparticles, particle/polymer hybrids, natural products, and colloid particles.

Statement 100: A system according to any one of the preceding Statements 83-99, further comprising a plurality of stressor modules coupled to the plurality of monitoring reservoirs, the plurality of stressor modules configured to introduce a stressor to at least one of the macromolecular solution samples received in the plurality of monitoring reservoirs.

Statement 101: A system according to Statement 100, wherein each of the plurality of stressor modules is coupled to at least one of the plurality of monitoring reservoirs and each stressor module is respectfully configured to introduce a stressor to the macromolecular solution sample contained in at least one of the plurality of monitoring reservoirs.

Statement 102: A system according to Statement 100 or Statement 101, wherein the stressor is selected from the group consisting of: a change in temperature, agitation, shearing ultrasonication, stirring, exposure to a gas/liquid interface, exposure to a metal, exposure to an oil, exposure to a plastic, exposure to a glass, exposure to a ceramic, change in pH, change in ionic strength, change in buffer type, change in buffer strength, a surfactant, metal ions, sugars, polysaccharides, and amino acids.

Statement 103: A system according to any one of the preceding Statements 83-102, wherein the computing device is further configured to cause an operation to be performed on one or more of the plurality of macromolecular solution samples received in the plurality of monitoring reservoirs at the determined time for performing an operation.

Statement 104: A system according to any one of the preceding Statements 83-103, wherein the operation comprises removing at least a portion of the macromolecular solution sample from a respective one of the plurality of monitoring reservoirs or transferring the at least a portion of the macromolecular solution sample to a sample testing device.

Statement 105: A system according to any one of the preceding Statements 83-104, wherein the computing device is further configured to cause at least one macromolecular solution sample received in a respective one of the plurality of monitoring reservoirs to be replaced by a second macromolecular solution sample.

Statement 106: A system according to any one of the preceding Statements 83-105, further comprising a sample transfer device coupled to the computing device, the sample transfer device configured to transfer at least one macromolecular solution sample received in the plurality of monitoring reservoirs, or portion thereof, to an analysis reservoir configured to receive a macromolecular solution sample for analytical testing.

Statement 107: A system according to Statement 106, wherein the sample transfer device is configured to transfer a corresponding one of the macromolecular solution samples to the analysis reservoir at the time for performing an operation determined by the computing device for the corresponding macromolecular solution sample.

Statement 108: A system according to any one of the preceding Statements 83-107, wherein the computing device is further configured to generate a schedule for the quantitative or qualitative analytical testing of at least one of the plurality of macromolecular solution samples based on the measured predetermined time dependent characteristic, and wherein the sample transfer device is configured to transfer a corresponding one of the macromolecular solution samples to the analysis reservoir based on the generated schedule.

Statement 109: A system according to any one of the preceding Statements 106-108, wherein the computing device is configured to cause the sample transfer device to transfer a corresponding one of the macromolecular solution samples to the analysis reservoir at the time for performing an operation determined by the computing device for the macromolecular solution sample.

Statement 110: A system according to any one of the preceding Statements 83-109, wherein the computing device is further configured to generate a schedule for the quantitative or qualitative analytical testing of at least one of the plurality of macromolecular solution samples based on the measured predetermined time dependent characteristic, and wherein the computing device is configured to cause the sample transfer device to transfer a corresponding one of the macromolecular solution samples to the analysis reservoir based on the generated schedule.

Statement 111: A system according to any one of the preceding Statements 106-110, wherein the sample transfer device is selected from the group consisting of: a robotic device, a Cartesian robotic arm, a translatable stage, a rotary stage, an automated sample cell holder, and an intelligent autosampler.

Statement 112: A system according to any one of the preceding Statements 106-111, wherein the sample transfer device is configured to target a macromolecular solution sample received in the plurality of monitoring reservoirs using a specified coordinate system or axis-grid.

Statement 113: A system according to any one of the preceding Statements 106-112, wherein the sample transfer device comprises a hollow needle or pipette configured to extract fluid from one or more of the plurality of monitoring reservoirs.

Statement 114: A system according to any one of the preceding Statements 83-113, further comprising a sample testing device comprising at least one analysis reservoir configured to receive a macromolecular solution sample, or portion thereof, from the sample transfer device, the sample testing device configured to perform at least one analytical test on at least one macromolecular solution sample received in the at least one analysis reservoir.

Statement 115: A system according to any one of the preceding Statements 106-114, wherein the sample testing device is selected from the group consisting of: gel permeation chromatography (GPC) instrument, differential scanning calorimetry (DSC) instrument, thermogravimetric analysis (TGA) instrument, an X-ray diffractometer, ultracentrifuge, electron microscope, calorimeter, and video microscope.

Statement 116: A system according to any one of the preceding Statements 106-115, wherein the sample testing device is configured to perform at least one analytical test selected from the group consisting of: gel permeation chromatography (GPC), differential scanning calorimetry (DSC), thermogravimetric analysis (TGA), X-ray diffraction, electron microscopy (EM), Mie scattering, dynamic light scattering (DLS), fluorescence, polarimetry, circular dichroism (Cd), circular birefringence, isothermal titration calorimetry, ultraviolet absorption, video microscopy, video particle sizing, light occlusion particle sizing, and ultracentrifugation.

Statement 117: A system according to any one of the preceding Statements 114-116, wherein the analysis reservoir is an automated sample cell holder or an intelligent autosampler.

Statement 118: A system according to any one of the preceding Statements 114-117, wherein the analysis reservoir is a sample loop of a GPC configured to inject a macromolecular solution sample, or a portion thereof, into a GPC column.

Statement 119: A system according to any one of the preceding Statements 114-118, wherein the sample testing device is configured to perform a plurality of analytical tests on at least one macromolecular solution sample received in the analysis reservoir at predetermined time points determined by the computing device based upon the predetermined time dependent characteristic measurements.

Statement 120: A system according to any one of the preceding Statements 114-119, further comprising at least one storage reservoir configured to receive a macromolecular solution sample, wherein the sample transfer device is configured to transfer at least one macromolecular solution sample received in the plurality of monitoring reservoirs, or portion thereof, to the at least one storage reservoir.

Statement 121: A system according to any one of the preceding Statements 114-120, wherein the computing device is further configured to, upon determining a delay, cause the sample transfer device to transfer a macromolecular solution sample, or portion thereof, to the at least one storage reservoir based on the time for performing an operation determination.

Statement 122: A system according to Statement 121, wherein the at least one storage reservoir is an automated sample cell holder or an intelligent autosampler.

1-56. (canceled)

57. A device comprising:
a plurality of monitoring reservoirs, each monitoring reservoir configured to receive a macromolecular solution sample;
a light scattering detection instrument coupled to the plurality of monitoring reservoirs, the light scattering detection instrument configured to monitor light scattering from a plurality of macromolecular solution samples received in the plurality of monitoring reservoirs; and
a computing device coupled to the light scattering detection instrument, the computing device configured to measure a predetermined time dependent characteristic of one or more of the macromolecular solution samples based on the monitored light scattering at the light scattering detection instrument;
wherein the computing device is further configured to determine a time for performing an operation on one or more of the plurality of macromolecular solution samples based on the predetermined time dependent characteristic measurement.

58. The device according to claim 57, wherein the computing device is configured to generate a schedule for the quantitative or qualitative analytical testing of at least one of the plurality of macromolecular solution samples based on the measured predetermined time dependent characteristic.

59. The device according to claim 57, wherein the operation is selected from the group consisting of: quantitative analytical testing, qualitative analytical testing, removing the macromolecular solution sample from the light scattering detection instrument, replacing the macromolecular solution sample at the light scattering detection instrument, introducing a stressor, transferring the macromolecular solution sample to a sample testing device, and transferring the macromolecular solution sample to a storage reservoir.

60. The device according to claim 57, wherein the light scattering detection instrument is configured to simultaneously monitor light scattering from two or more of the plurality of macromolecular solution samples received in the plurality of monitoring reservoirs.

61. The device according to claim 57, wherein the light scattering detection instrument is configured to monitor in series light scattering from the plurality of macromolecular solution samples received in the plurality of monitoring reservoirs.

62. The device according to claim 57, further comprising a plurality of stressor modules coupled to the plurality of monitoring reservoirs, the plurality of stressor modules configured to introduce a stressor to at least one of the macromolecular solution samples received in the plurality of monitoring reservoirs.

63. The device according to claim 57, wherein the computing device is further configured to cause an operation to be performed on one or more of the plurality of macromolecular solution samples received in the plurality of monitoring reservoirs at the determined time for performing an operation.

64. The device according to claim 57, further comprising a sample transfer device coupled to the computing device, the sample transfer device configured to transfer at least one macromolecular solution sample received in the plurality of monitoring reservoirs, or portion thereof, to an analysis reservoir configured to receive a macromolecular solution sample for analytical testing.

65. The device according to claim 64, wherein the sample transfer device is configured to transfer a corresponding one of the macromolecular solution samples to the analysis reservoir at the time for performing an operation determined by the computing device for the corresponding macromolecular solution sample.

66. The device according to claim 64, wherein the computing device is further configured to generate a schedule for the quantitative or qualitative analytical testing of at least one of the plurality of macromolecular solution samples based on the measured predetermined time dependent characteristic, and wherein the sample transfer device is configured to transfer a corresponding one of the macromolecular solution samples to the analysis reservoir based on the generated schedule.

67. The device according to claim 64, wherein the computing device is further configured to generate a schedule for the quantitative or qualitative analytical testing of at least one of the plurality of macromolecular solution samples based on the measured predetermined time dependent characteristic, and wherein the computing device is configured to cause the sample transfer device to transfer a corresponding one of the macromolecular solution samples to the analysis reservoir based on the generated schedule.

68. The device according to claim 64, further comprising a sample testing device comprising at least one analysis reservoir configured to receive a macromolecular solution sample, or portion thereof, from the sample transfer device, the sample testing device configured to perform at least one analytical test on at least one macromolecular solution sample received in the at least one analysis reservoir.

69. The device according to claim 68, wherein the sample testing device is configured to perform a plurality of analytical tests on at least one macromolecular solution sample received in the analysis reservoir at predetermined time points determined by the computing device based upon the predetermined time dependent characteristic measurements.

70. The device according to claim 68, further comprising at least one storage reservoir configured to receive a macromolecular solution sample, wherein the sample transfer device is configured to transfer at least one macromolecular solution sample received in the plurality of monitoring reservoirs, or portion thereof, to the at least one storage reservoir.

71. The device according to claim 70, wherein the computing device is further configured to, upon determining a delay, cause the sample transfer device to transfer a macromolecular solution sample, or portion thereof, to the at least one storage reservoir based on the time for performing an operation determination.

72. A method of scheduling analytical testing on a macromolecular solution comprising:
monitoring, at a light scattering detection instrument, light scattering from two or more macromolecular solution samples;
measuring, at a computing device, a predetermined time dependent characteristic of the two or more macromolecular solution samples based on the monitored light scattering at the light scattering detection instrument; and
determining, at the computing device, a time for performing an operation on at least one of the two or more macromolecular solution samples based on a change in the predetermined time dependent characteristic measurement.

73. The method according to claim 72, further comprising:
causing, at the computing device, the performance of the operation on at least one of the two or more macromolecular solution samples at the determined time for performing the operation;
generating a schedule for the quantitative or qualitative analytical testing of at least one of the two or more macromolecular solution samples based on the determined time for performing an operation, wherein the schedule comprises a plurality of predetermined times for quantitative or qualitative analytical testing of the same macromolecular solution sample, or a portion thereof;
transferring, using a sample transfer device, at least one of the two or more macromolecular solution samples, or a portion thereof, to a sample testing device based on the generated schedule; and
performing, at the sample testing device, a plurality of quantitative or qualitative analytical tests on the same macromolecular solution sample according to the schedule comprising a plurality of predetermined times.

74. The method according to claim 73, further comprising replacing, at the light scattering detection instrument, at least one of the two or more macromolecular solution samples with a new macromolecular solution sample based on the generated schedule.

75. A device comprising:
a light scattering device configured to monitor light scattering from a plurality of macromolecular solution samples; and
at least one processor in communication with the light scattering device, wherein the processor is coupled with a non-transitory computer readable storage medium having stored therein instructions which, when executed by the at least one processor, causes the processor to:
measure a predetermined time dependent characteristic of the plurality of macromolecular solution samples based on the monitored light scattering at the light scattering detection instrument;
determine a time for performing an operation on at least one of the plurality macromolecular solution samples based on a change in the predetermined time dependent characteristic measurement;
generating a schedule for the quantitative or qualitative analytical testing of at least one of the two or more macromolecular solution samples based on the determined time for performing an operation; and
cause the transfer, using the sample transfer device, of at least one macromolecular solution sample, or a portion thereof, to a sample testing device based on the generated schedule.

76. The device according to claim 75, further comprising a sample testing device, wherein the non-transitory computer-readable storage medium further contains a set of instructions that when executed by the at least one processor further causes the processor to:
cause the performance of a quantitative or qualitative analytical test on the transferred macromolecular solution sample using the sample testing device based on the generated schedule.
